(19) United States
(12) Patent Application Publication
(10) Pub. No.: US 2004/0215351 A1
(43) Pub. Date: Oct. 28, 2004

(54) System for disposing of waste and method of doing the same

(76) Inventors: Hiroshi Kiire, Tokyo (JP); Toshinori Seki, Tokyo (JP); Yoshihiro Tanabe, Tokyo (JP); Kiyoshi Nagatsuka, Tokyo (JP)

Correspondence Address: DICKSTEIN SHAPIRO MORIN & OSHINSKY LLP, 1177 AVENUE OF THE AMERICAS (6TH AVENUE), 41 ST FL., NEW YORK, NY, 10036-2714, US

(21) Appl. No.: 10/831,185

(22) Filed: Apr. 26, 2004

(30) Foreign Application Priority Data
Apr. 25, 2003 (JP) 2003-121291

(51) Int. Cl. G05B 15/00

(52) U.S. Cl. 700/1

(57) ABSTRACT

A system for disposing of wastes, in accordance with the present invention includes a plurality of terminal devices located at sites in which steps in a waste-recycling process are carried out, a network, and a host server making communication with the terminal devices through the network. Each of the terminal devices transmits data indicative of a condition of waste in each of the steps, to the host server, and the host server compares the data in each of the steps to one another to judge whether the condition of waste changes in each of the steps.

### BACKGROUND OF THE INVENTION

1. Field of the Invention

The invention relates to a system for disposing of waste and a method of doing the same, and more particularly to such a system and a method both providing data indicative of a progress of waste disposal through a network.

2. Description of the Related Art

Recently, environment is frequently destructed by illegal dumping of industrial and non-industrial wastes. Apart from prohibition of illegal dumping of wastes, many suggestions have been made to reuse and recycle wastes.

Most of countries have a law which prohibits illegal dumping of wastes. Such a law generally has an article for facilitating reduction and reuse/recycle of wastes. However, such a law is not effective for prohibiting illegal dumping of wastes.

There have been suggested a lot of systems for reusing and/or recycling all or a part of wastes. However, it is quite difficult or almost impossible to check an operation of the system at a time convenient for a user.

Some industrial-waste disposers gather wastes all over a country. However, there has not been suggested a system for such industrial-waste disposers to monitor wastes in a recycling process.

### SUMMARY OF THE INVENTION

In view of the above-mentioned problems in the prior art, it is an object of the present invention to provide a system for disposing of waste and a method of doing the same both of which is capable of preventing illegal dumping of waste during a process for reusing and/or recycling the same.

It is also an object of the present invention to provide a server capable of doing the same, and a program causing a computer to carry out the above-mentioned method.

Hereinbelow are described the above-mentioned system, method, server and program in accordance with the present invention through the use of reference numerals used in later described embodiments. The reference numerals are indicated only for the purpose of clearly showing correspondence between claims and the embodiments. It should be noted that the reference numerals are not allowed to use in the interpretation of claims of the present application.

In one aspect of the present invention, there is provided a system for disposing of wastes, including a central processing unit (11) which receives data indicative of a condition of waste in each of steps in a waste-recycling process, compares the data in each of the steps to one another, and judges whether the condition of waste changes in each of the steps.

For instance, the central processing unit (11) judges whether a part or parts constituting the waste is (are) in short in each of the steps.

There is further provided a system for disposing of wastes, including a plurality of terminal devices (20, 30, 40, 50, 60, 70) located at sites (Pt1, Pt2, Pt3, Pt4, Pt5) in which steps in a waste-recycling process are carried out, a network (1), and a host server (10) making communication with the terminal devices (20, 30, 40, 50, 60, 70) through the network (1), wherein each of the terminal devices (20, 30, 40, 50, 60, 70) transmits data indicative of a condition of waste in each of the steps, to the host server (10), and the host server (10) compares the data in each of the steps to one another to judge whether the condition of waste changes in each of the steps.

For instance, the host server (10) judges whether a part or parts constituting the waste is (are) in short in each of the steps.

For instance, the host server (10) compares the data indicative of a condition of waste before the waste is carried to the data indicative of a condition of the waste after the waste is carried.

For instance, the host server (10) compares the data indicative of a condition of waste before the waste is disassembled to the data indicative of a condition of the waste after the waste is disassembled.

It is preferable that each of the terminal devices (20, 30, 40, 50, 60, 70) transmits image data of the waste in each of the steps to the host server (10).

It is preferable that each of the terminal devices (20, 30, 40, 50, 60, 70) transmits data indicative of a weight of the waste in each of the steps to the host server (10), and the host server (10) compares the data to one another to judge whether a weight of the waste reduces.

It is preferable that each of the terminal devices (20, 30, 40, 50, 60, 70) transmits data indicative of a number of parts constituting the waste in each of the steps to the host server (10), and the host server (10) compares the data to one another to judge whether the number of parts reduces.

It is preferable that the host server (10) includes a memory storing therein data indicative of whether a part or parts constituting the waste include(s) hazardous material, each of the terminal devices (20, 30, 40, 50, 60, 70) transmits data indicative of parts constituting the waste to the host server (10), and the host server (10) compares the data received from each of the terminal devices (20, 30, 40, 50, 60, 70) to the data stored in the memory to judge whether the parts constituting the waste include the hazardous material.

The system may further include a waste-dumper's terminal device (20) making communication with the host server (10) through the network (1) and operated by a waste-dumper (200), in which case, the host server (10) receives data transmitted from each of the terminal devices (20, 30, 40, 50, 60, 70), stores the received data therein, and transmits the data to the waste-dumper's terminal device (20) on receipt of a request to do so from the waste-dumper's terminal device (20).

It is preferable that each of the terminal devices (20, 30, 40, 50, 60, 70) transmits data indicative of date and time at which each of the steps was carried out, to the host server (10).

It is preferable that each of the terminal devices (20, 30, 40, 50, 60, 70) transmits data indicative of a condition of the waste in at least one of a waste-gathering step and a waste-disassembling/grouping step, to the host server (10).

In another aspect of the present invention, there is provided a method of disposing of wastes, including (a) producing data indicative of a condition of waste in each of steps in a waste-recycling process, (b) comparing the data in each of the steps to one another, and (c) judging whether the condition of waste changes in each of the steps.

For instance, it is judged in the step (c) whether a part or parts constituting the waste is (are) in short in each of the steps.

There is further provided a method of disposing of wastes through a system including a plurality of terminal devices (20, 30, 40, 50, 60, 70) located at sites (Pt1, Pt2, Pt3, Pt4, Pt5) in which steps in a waste-recycling process are carried out, a network (1), and a host server (10) making communication with the terminal devices (20, 30, 40, 50, 60, 70) through the network (1), the method including (a) transmitting data indicative of a condition of waste in each of the steps, to the host server (10) from each of the terminal devices (20, 30, 40, 50, 60, 70), and (b) comparing the data in each of the steps to one another in the host server (10) to judge whether the condition of waste changes in each of the steps.

For instance, it is judged in the step (b) whether a part or parts constituting the waste is (are) in short in each of the steps.

It is preferable that the data indicative of a condition of waste before the waste is carried is compared in the step (b) to the data indicative of a condition of the waste after the waste is carried.

It is preferable that the data indicative of a condition of waste before the waste is disassembled is compared in the step (b) to the data indicative of a condition of the waste after the waste is disassembled.

It is preferable that image data of the waste in each of the steps is transmitted in the step (a) to the host server (10) from each of the terminal devices (20, 30, 40, 50, 60, 70).

It is preferable that data indicative of a weight of the waste in each of the steps is transmitted in the step (a) to the host server (10) from each of the terminal devices (20, 30, 40, 50, 60, 70), and the data is compared in the step (b) to one another to judge whether a weight of the waste reduces.

It is preferable that each of the terminal devices (20, 30, 40, 50, 60, 70) transmits data indicative of a number of parts constituting the waste in each of the steps to the host server (10), and the host server (10) compares the data to one another to judge whether the number of parts reduces.

The method may further include storing data indicative of whether a part or parts constituting the waste include(s) hazardous material, into a memory of the host server (10), and wherein data indicative of parts constituting the waste is transmitted in the step (a) to the host server (10) from each of the terminal devices (20, 30, 40, 50, 60, 70), and the data received from each of the terminal devices (20, 30, 40, 50, 60, 70) is compared in the step (b) to the data stored in the memory to judge whether the parts constituting the waste include the hazardous material.

The method further include transmitting the data to a waste-dumper's terminal device (20) making communication with the host server (10) through the network (1) and operated by a waste-dumper (200), on receipt of a request to do so from the waste-dumper's terminal device (20).

It is preferable that data indicative of date and time at which each of the steps was carried out is transmitted in the step (a) to the host server (10) from each of the terminal devices (20, 30, 40, 50, 60, 70).

It is preferable that data indicative of a condition of the waste in at least one of a waste-gathering step and a waste-disassembling/grouping step is transmitted to the host server (10) from each of the terminal devices (20, 30, 40, 50, 60, 70).

In still another aspect of the present invention, there is provided a program for causing a computer to carry out a method of disposing of wastes, wherein steps executed by the computer in accordance with the program include (a) receiving data indicative of a condition of waste in each of steps in a waste-recycling process, (b) comparing the data in each of the steps to one another, and (c) judging whether the condition of waste changes in each of the steps.

For instance, it is judged in the step (c) whether a part or parts constituting the waste is (are) in short in each of the steps.

It is preferable that the data indicative of a condition of waste before the waste is carried is compared in the step (b) to the data indicative of a condition of the waste after the waste is carried.

It is preferable that the data indicative of a condition of waste before the waste is disassembled is compared in the step (b) to the data indicative of a condition of the waste after the waste is disassembled.

It is preferable that image data of the waste in each of the steps is received in the step (a).

It is preferable that data indicative of a weight of the waste in each of the steps is received in the step (a), and the data is compared in the step (b) to one another to judge whether a weight of the waste reduces.

It is preferable that data indicative of a number of parts constituting the waste in each of the steps is received in the step (a), and the data is compared in the step (b) to one another to judge whether the number of parts reduces.

It is preferable that data indicative of parts constituting the waste is received in the step (a), and the data is compared in the step (b) to data indicative of whether a part or parts constituting the waste include(s) hazardous material, to judge whether the parts constituting the waste include the hazardous material.

It is preferable that the steps executed by the computer include transmitting the data to a waste-dumper's terminal device (20) making communication with the host server (10) through the network (1) and operated by a waste-dumper (200), on receipt of a request to do so from the waste-dumper's terminal device (20).

In yet another aspect of the present invention, there is provided a server (10) which collects data indicative of a condition of waste in each of steps in a waste-recycling process, compares the data in each of the steps to one another, and judges whether the condition of waste changes in each of the steps.

For instance, the server (10) judges whether a part or parts constituting the waste is (are) in short in each of the steps.

For instance, the server (10) judges whether a part or parts constituting the waste is (are) in short in each of the steps.

For instance, the server (10) compares the data indicative of a condition of waste before the waste is carried to the data indicative of a condition of the waste after the waste is carried.

For instance, the server (10) compares the data indicative of a condition of waste before the waste is disassembled to the data indicative of a condition of the waste after the waste is disassembled.

For instance, the server (10) receives image data of the waste in each of the steps.

For instance, the server (10) receives data indicative of a weight of the waste in each of the steps, and compares the data to one another to judge whether a weight of the waste reduces.

For instance, the server (10) receives data indicative of a number of parts constituting the waste in each of the steps, and compares the data to one another to judge whether the number of parts reduces.

The server (10) may further include a memory (17) storing therein data indicative of whether a part or parts constituting the waste include(s) hazardous material, in which case, the server (10) receives data indicative of parts constituting the waste to the host server (10), and compares the received data to the data stored in the memory (17) to judge whether the parts constituting the waste include the hazardous material.

The advantages obtained by the aforementioned present invention will be described hereinbelow.

In accordance with the present invention, it is checked whether waste is illegally dumped by comparing image data, a weight and/or a number of parts constituting waste in each of steps in a waste-recycling process, and then, the check results are output in the form of a report. Hence, it is possible to prevent illegal dumping of waste in a waste-recycling process.

In accordance with the present invention, a waste-dumper may request a host server to transmit data indicative of waste dumped by himself/herself to his/her terminal device. On receipt of a request from a waste-dumper, the host server carries out authentication as to whether a person who transmitted a request is really a waste-dumper, and then, if the person is really a waste-dumper, the host server transmits data indicative of a progress in recycling his/her waste and/or results of checking whether his/her waste is illegally dumped, to the waste-dumper.

Accordingly, a waste-dumper can readily and soon check whether his/her waste is legally disposed of in a process of recycling his/her waste. Furthermore, it is possible to prevent data relating to his/her waste from leaking to a third party.

In accordance with the present invention, each of terminals transmits data indicative of parts constituting waste, to a host server. On receipt of the data, the host server checks whether the parts contain hazardous material. Hence, a waste-recycler can readily know whether the waste contains hazardous material, and can properly collect and recycle waste.

The above and other objects and advantageous features of the present invention will be made apparent from the following description made with reference to the accompanying drawings, in which like reference characters designate the same or similar parts throughout the drawings.

### BRIEF DESCRIPTION OF THE DRAWINGS

FIG. 1 is a block diagram showing a waste-recycling system to which a system for disposing of waste in accordance with the first embodiment of the present invention is applied.

FIG. 2 is a block diagram of a system for disposing of waste in accordance with the first embodiment of the present invention.

FIG. 3 is a block diagram of a host server partially constituting the system in accordance with the first embodiment of the present invention.

FIG. 4 illustrates an example of client data stored in a client-data memory in the system in accordance with the first embodiment of the present invention.

FIG. 5 is a block diagram of an example of a client-data memory in the system in accordance with the first embodiment of the present invention.

FIG. 6 is a block diagram of a terminal device of a waste-dumper in the system in accordance with the first embodiment of the present invention.

FIG. 7 is a block diagram of a terminal device of a waste-collector in the system in accordance with the first embodiment of the present invention.

FIG. 8 is a block diagram of a terminal device located at a waste-gathering site in the system in accordance with the first embodiment of the present invention.

FIG. 9 is a block diagram of a terminal device located at a site in which reusable parts are extracted out of waste, in the system in accordance with the first embodiment of the present invention.

FIG. 10 is a block diagram of a terminal device located at a site in which recyclable parts are extracted out of waste, in the system in accordance with the first embodiment of the present invention.

FIG. 11 is a block diagram of a terminal device located at a site in which recyclable and reusable parts are used in making a product, in the system in accordance with the first embodiment of the present invention.

FIG. 12 is a flow-chart showing steps to be carried out in the system in accordance with the first embodiment of the present invention.

FIG. 13 illustrates an example of an image plane of registration in the system in accordance with the first embodiment of the present invention.

FIG. 14 is a flow-chart showing steps to be carried out when data indicative of hazardous material is transmitted between a terminal device and a host server, in the system in accordance with the first embodiment of the present invention.

FIG. 15 illustrates an example of a hazardous material database in the system in accordance with the first embodiment of the present invention.

FIG. 16 is a flow-chart showing steps to be carried out when image data is transmitted between a terminal device and a host server, in the system in accordance with the first embodiment of the present invention.

FIG. 17 is a flow-chart showing steps to be carried out when data indicative of a weight of waste is transmitted between a terminal device and a host server, in the system in accordance with the first embodiment of the present invention.

FIG. 18 is a flow-chart showing steps to be carried out when data indicative of a number of parts constituting waste is transmitted between a terminal device and a host server, in the system in accordance with the first embodiment of the present invention.

FIG. 19 illustrates an example of waste-administration data including image plane data, weight data and part-number data which are input at a site in which waste is collected, in the system in accordance with the first embodiment of the present invention.

FIG. 20 is a flow-chart showing steps to be carried out when it is judged whether waste is illegally dumped at a site in which waste is gathered, in the system in accordance with the first embodiment of the present invention.

FIG. 21 is a flow-chart showing steps to be carried out when it is judged whether waste is illegally dumped at a site in which waste is gathered, in the system in accordance with the first embodiment of the present invention.

FIG. 22 illustrates an example of waste-administration data including image plane data, weight data and part-number data which are input at a site in which waste is gathered, in the system in accordance with the first embodiment of the present invention.

FIG. 23 shows conditional expressions in accordance with which it is judge whether waste is legally disposed of, based on weight data, in the system in accordance with the first embodiment of the present invention.

FIG. 24 shows conditional expressions in accordance with which it is judge whether waste is legally disposed of, based on part-number data, in the system in accordance with the first embodiment of the present invention.

FIG. 25 is a flow-chart showing steps to be carried out when it is judged whether waste is illegally dumped at a site in which reusable parts are extracted out of waste, in the system in accordance with the first embodiment of the present invention.

FIG. 26 is a flow-chart showing steps to be carried out when it is judged whether waste is illegally dumped at a site in which reusable parts are extracted out of waste, in the system in accordance with the first embodiment of the present invention.

FIG. 27 is a flow-chart showing steps to be carried out when it is judged whether waste is illegally dumped at a site in which recyclable parts are extracted out of waste, in the system in accordance with the first embodiment of the present invention.

FIG. 28 is a flow-chart showing steps to be carried out when it is judged whether waste is illegally dumped at a site in which recyclable parts are extracted out of waste, in the system in accordance with the first embodiment of the present invention.

FIG. 29 illustrates an example of recycle data stored in a memory in the system in accordance with the first embodiment of the present invention.

FIG. 30 is a flow-chart showing steps to be carried out when an order for reusable and recyclable parts is made in the system in accordance with the first embodiment of the present invention.

FIG. 31 illustrates an example of an image plane for selling usable and recyclable parts in the system in accordance with the first embodiment of the present invention.

FIG. 32 illustrates an example of data indicative of a progress in disposal of waste in the system in accordance with the first embodiment of the present invention.

FIG. 33 is a flow-chart showing steps to be carried out when data relating to waste is obtained in the system in accordance with the first embodiment of the present invention.

FIG. 34 illustrates an example of recycle data to be transmitted to a waste-dumper in the system in accordance with the first embodiment of the present invention.

### DESCRIPTION OF THE PREFERRED EMBODIMENTS

Preferred embodiments in accordance with the present invention will be explained hereinbelow with reference to drawings.

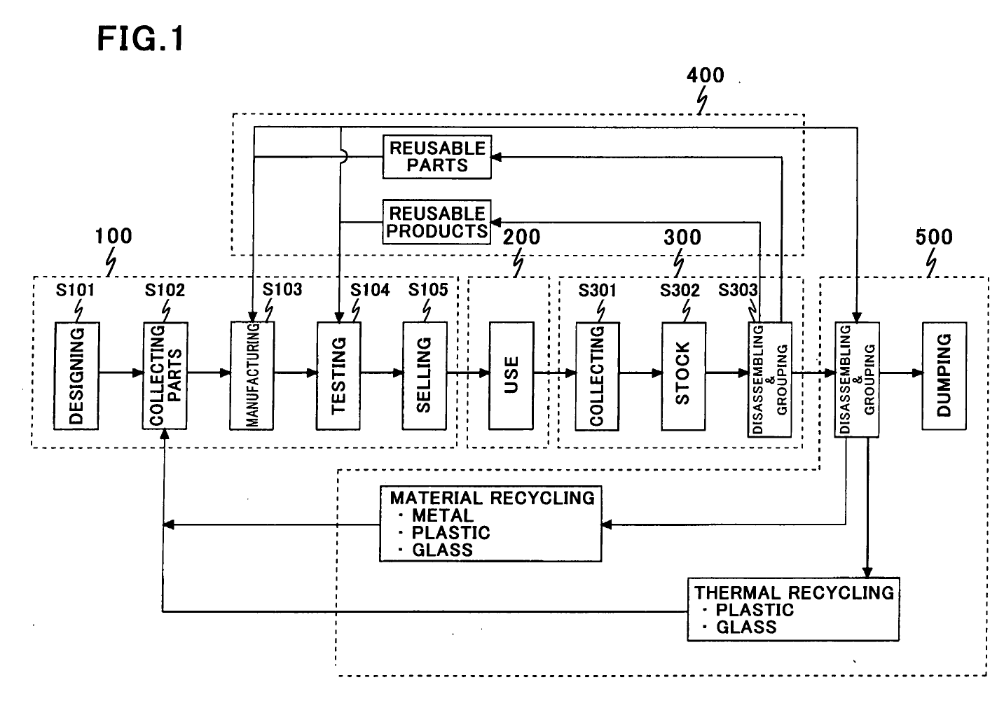

FIG. 1 is a block diagram showing a waste-recycling system to which a system for disposing of waste in accordance with the first embodiment of the present invention is applied.

Hereinbelow is explained a process of reusing and recycling waste in accordance with arrows in FIG. 1.

A manufacture 100 designs a product such as an electronic device in step S101, purchases parts for manufacturing the product in step S102, manufactures the produce in step S103, checks whether the product has defects in step S104, and sells the product to a user 200 in step S105.

The user 200 purchases the produce from the manufacturer 100, uses the product, and dumps the product as waste because of failures or long use. Thus, the user 200 is called hereinafter a waste-dumper.

A waste-collector 300 collects waste from a lot of the users 200 in step S301, keeps them in a warehouse in step S302, groups the products into reusable ones and non-reusable ones, disassembles the non-reusable products into parts, and groups the parts into reusable ones and non-reusable one in step S303.

Among the thus grouped or disassembled products and parts, the waste-collector 300 provides reusable products and parts to a waste-reuser 400. For instance, the waste-collector 300 disassembles an electronic device into parts, and provides reusable parts such as a printed wiring board or a connector to the waste-reuser 400.

Among the products and parts, the non-reusable products and parts are carried to a waste-recycler 500 from the waste-collector 300.

If necessary, the waste-reuser 400 further disassembles the products and parts received from the waste-collector 300. The waste-reuser 400 transfers products and parts which are not reusable as they are because of failure or breakage, to the waste-recycler 500. On the other hand, the waste-reuser 400 sells reusable products and parts to the manufacturer 100.

The waste-recycler 500 further groups and disassembles the products and parts carried from the waste-collector 300 and the waste-recycler 400, into recyclable ones and non-recyclable ones. Non-recyclable products and parts are carried to an industrial waste disposer. The waste-recycler 500 transfers parts which are recyclable as they are, such as metal, plastic and glass, to the manufacturer 100. If necessary, the waste-recycler 500 applies heat treatment to parts such as plastics and glass, and then, transfers them to the manufacturer 100.

The manufacturer 100 tests quality of the products and parts received from the waste-reuser 400 and the waste-recycler 500 as to whether they can be provided to a user as they are (step S104). If the products and parts pass the quality test, the manufacturer 100 sells them to a user (step S105). Among the products and parts received from the waste-reuser 400 and the waste-recycler 500, recyclable ones are used as parts constituting a product (step S103). The product is tested as to quality (step S104), and sold to a user (step S105), if the product passes the quality test.

Waste is dumped, reused or recycled in the above-mentioned way. The system for disposing of waste in accordance with the first embodiment of the present invention receives and monitors data relating to waste, transmitted from each of the manufacturer 100, the waste-dumper 200, the waste-collector 300, the waste-reuser 400 and the waste-recycler 500 to thereby prevent illegal dumping of waste.

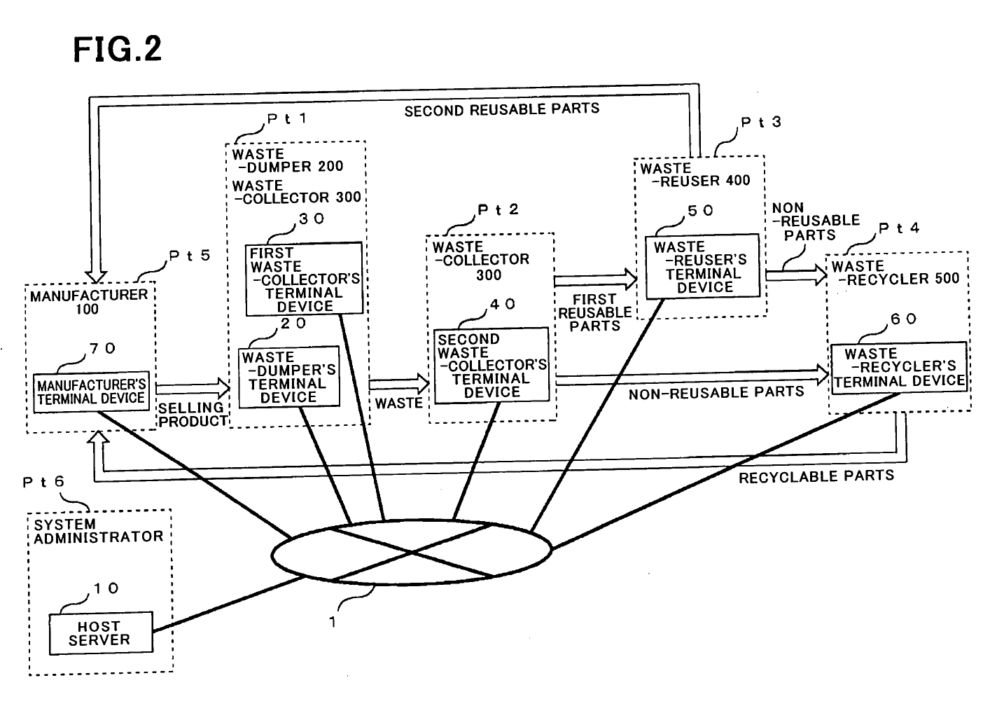

FIG. 2 is a block diagram of the system for disposing of waste in accordance with the first embodiment of the present invention.

As illustrated in FIG. 2, the system is comprised of a host server 10, a waste-dumper's terminal device 20, a first waste-collector's terminal device 30, a second waste-collector's terminal device 40, a waste-reuser's terminal device 50, a waste-recycler's terminal device 60, a manufacturer's terminal device 70, and a network 1 through which the host server 10 and the terminal devices 20, 30, 40, 50, 60 and 70 make communication with one another.

Though each of the terminal devices 20, 30, 40, 50, 60 and 70 is illustrated as a single terminal device, each of the terminal devices 20, 30, 40, 50, 60 and 70 may be comprised of a plurality of terminal devices.

The host server 11 is placed at a data-administration site Pt6, and is operated by a system administrator. For instance, the host server 11 is comprised of a high-end personal computer such as a workstation. When the network 1 is comprised of Internet, the host server 10 acts as a web server.

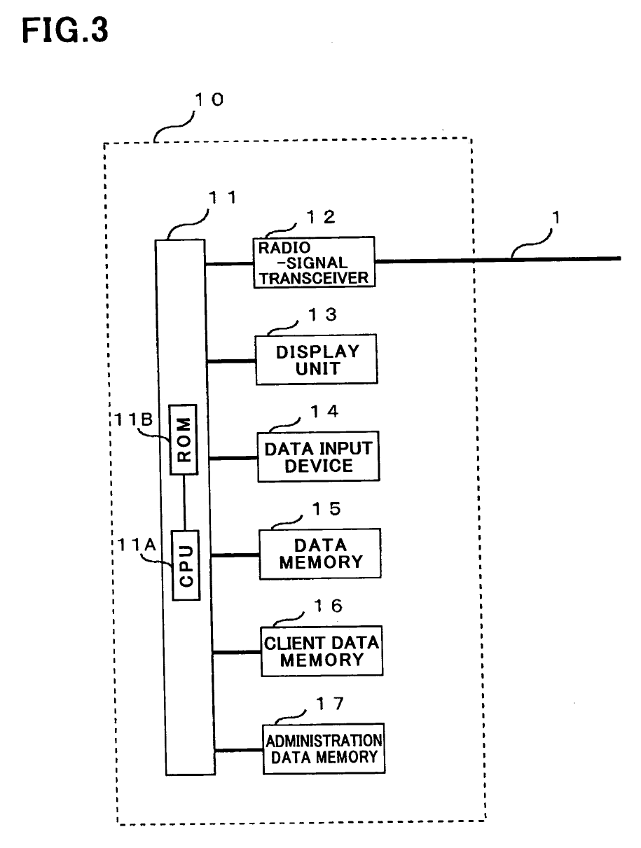

FIG. 3 is a block diagram of the host server 10 in the first embodiment.

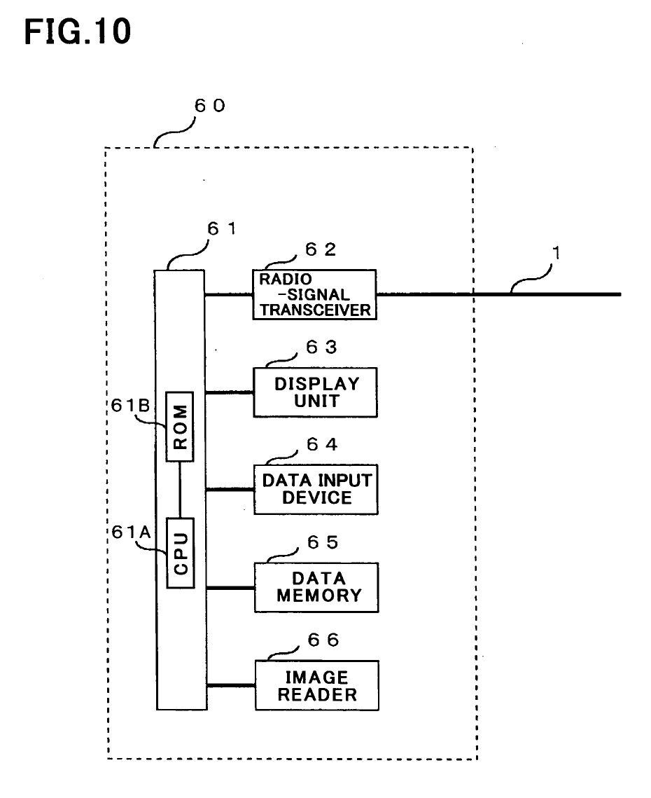

As illustrated in FIG. 10, the host server 10 is comprised of a controller 11, a radio-signal transceiver 12, a display unit 13, a data input device 14, a data memory 15, a client data memory 16, and an administration data memory 17.

The controller 11 is comprised of a central processing unit 11A and a memory 11B.

The memory 11B is comprised of a semiconductor memory such as a read only memory (ROM), a random access memory (RAM) or an IC memory card, or a storage device such as a flexible disc, a hard disc or an optic magnetic disc.

The memory 11B stores therein a program for controlling the central processing unit 11A. The central processing unit 11A reads the program out of the memory 11B, and executes the program. Thus, the central processing unit 11A operates in accordance with the program stored in the memory 11B.

The controller 11 is electrically connected to the radio-signal transceiver 12, the display unit 13, the data input device 14, the data memory 15, the client data memory 16, and the administration data memory 17, and controls operation of them.

The radio-signal transceiver 12 is connected to the network 1. The host server 10 transmits radio-signals to the terminal devices 20-70 through the radio-signal transceiver 12 and the network 1, and receives radio-signals from the terminal devices 20-70 through the radio-signal transceiver 12 and the network 1.

The display unit 13 displays data input into the host server 10 by a system administrator through the data input device 14 and data received from the terminal devices 20-70. For instance, the display unit 13 is comprised of a cathode ray tube (CRT), a liquid crystal display (LCD) device or an organic electroluminescence (EL) display.

A system administrator inputs data into the host server 10 through the data input device 14. For instance, the data input device 14 is comprised of a keyboard including a plurality of keys.

The data memory 15 stores various data such as data relating to web pages.

The client data memory 16 stores data relating to clients.

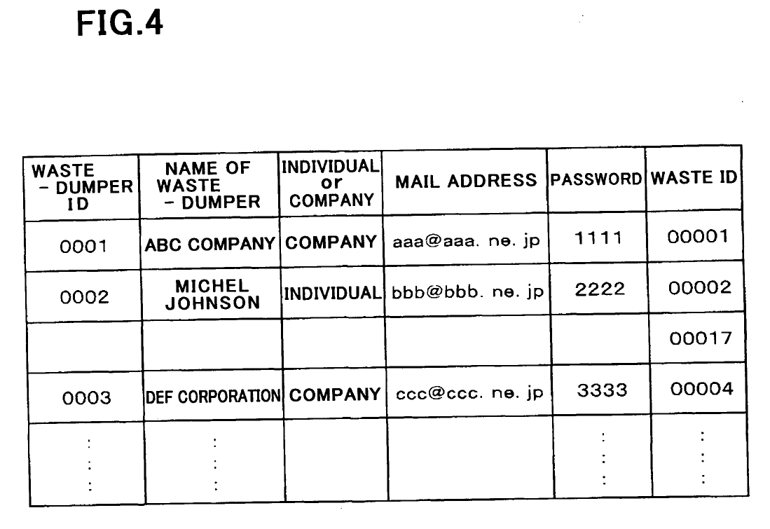

FIG. 4 illustrates an example of client data stored in the client data memory 16 in the first embodiment.

As illustrated in FIG. 4, an ID of a waste-dumper, a name of the waste-dumper, indication as to whether the waste-dumper is an individual or a company, an address of the waste-dumper, a password used or making access to client data and waste-administration data, and a waste ID for identifying waste dumped by the waste-dumper are stored in the client data memory 16 in association with one another.

The administration data memory 17 stores data relating to wastes dumped by waste-dumpers.

For instance, each of the data memory 15, the client data memory 16 and the administration data memory 17 is comprised of a semiconductor memory such as a read only memory (ROM), a random access memory (RAM) or an IC memory card, or a storage device such as a flexible disc, a hard disc or an optic magnetic disc.

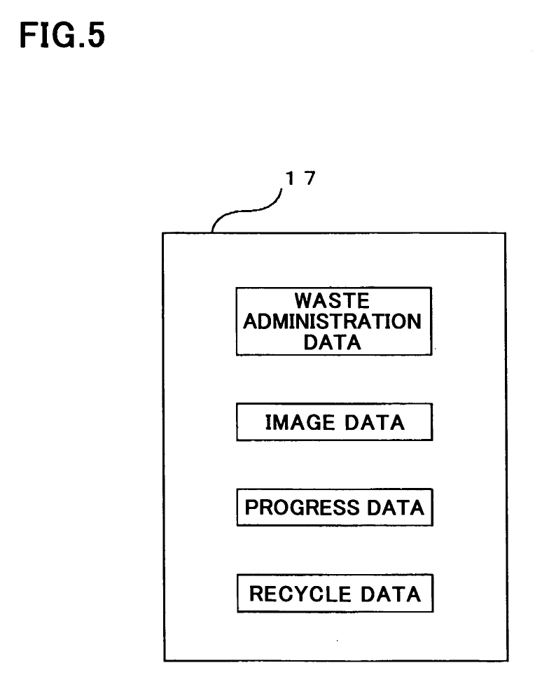

FIG. 5 is a block diagram of the administration data memory 17.

As illustrated in FIG. 5, the administration data memory 17 stores waste administration data, image data, progress data and recycle data.

The waste administration data indicates how waste is disposed of in each of later-mentioned sites Pt1, Pt2, Pt3 and Pt4.

The image data indicates images of wastes in each of the sites Pt1, Pt2, Pt3 and Pt4.

The progress data indicates progress in a process of disposing of wastes. Specifically, the progress data indicates where waste is now and which stage waste is in.

The recycle data indicates products recycled from wastes. For instance, the recycle data indicates which waste a product was recycled from, which client a product was sold, and so on.

In the administration data memory 17 are stored the above-mentioned waste administration data, image data, progress data and recycle data in association with a waste ID. The waste administration data, image data, progress data and recycle data can be liked to client data of a waste-dumper who dumped the waste, through the waste ID.

The waste-dumper's terminal device 20 is operated by the waste-dumper 200, and is placed at a site Pt1 where wastes dumped by the waste-dumper 200 are collected by the waste-collector 300.

For instance, the waste-dumper's terminal device 20 is comprised of a desk-top type personal computer, or a mobile terminal device such as a cellular phone capable of making communication with the network 1, a terminal of a personal handy-phone system (PHS), a personal digital assistant (PDA) or a note-book type personal computer.

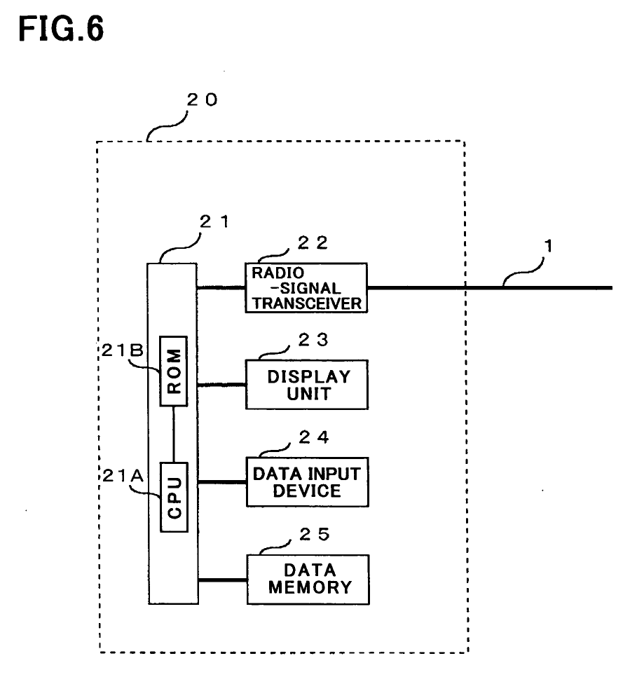

FIG. 6 is a block diagram of the waste-dumper's terminal device 20 in the first embodiment.

As illustrated in FIG. 10, the waste-dumper's terminal device 20 is comprised of a controller 21, a radio-signal transceiver 22, a display unit 23, a data input device 24, and a data memory 25.

The controller 21 is comprised of a central processing unit 21A and a memory 21B.

The memory 21B is comprised of a semiconductor memory such as a read only memory (ROM), a random access memory (RAM) or an IC memory card, or a storage device such as a flexible disc, a hard disc or an optic magnetic disc.

The memory 21B stores therein a program for controlling the central processing unit 21A. The central processing unit 21A reads the program out of the memory 21B, and executes the program. Thus, the central processing unit 21A operates in accordance with the program stored in the memory 21B.

The controller 21 is electrically connected to the radio-signal transceiver 22, the display unit 23, the data input device 24 and the data memory 25, and controls operation of them.

The radio-signal transceiver 22 is connected to the network 1. The waste-dumper's terminal device 20 transmits radio-signals to the host server 10 through the radio-signal transceiver 22 and the network 1, and receives radio-signals from the host server 10 through the radio-signal transceiver 22 and the network 1.

The display unit 23 displays data input into the waste-dumper's terminal device 20 by a user through the data input device 24 and data received from the host server 10. For instance, the display unit 23 is comprised of a cathode ray tube (CRT), a liquid crystal display (LCD) device or an organic electroluminescence (EL) display.

A user inputs data into the waste-dumper's terminal device 20 through the data input device 24. For instance, the data input device 24 is comprised of a keyboard including a plurality of keys.

The data memory 25 stores various data therein.

For instance, the data memory 25 is comprised of a semiconductor memory such as a read only memory (ROM), a random access memory (RAM) or an IC memory card, or a storage device such as a flexible disc, a hard disc or an optic magnetic disc.

The first waste-collector's terminal device 30 is operated by the waste-collector 300, and is placed at the site Pt1 to collect data relating to waste dumped by the waste-dumper 200.

For instance, the first waste-collector's terminal device 30 is comprised of a desk-top type personal computer, or a mobile terminal device such as a cellular phone capable of making communication with the network 1, a terminal of a personal handy-phone system (PHS), a personal digital assistant (PDA) or a note-book type personal computer.

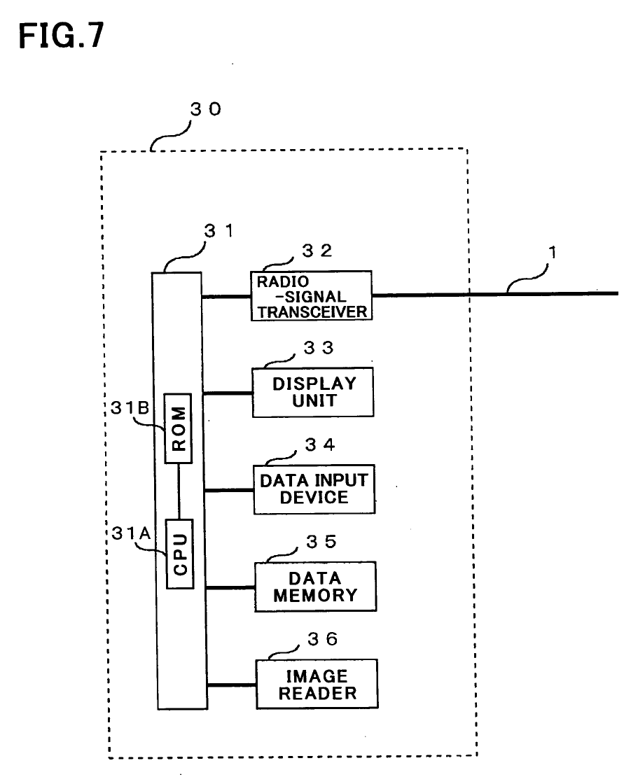

FIG. 7 is a block diagram of the first waste-collector's terminal device 30 in the first embodiment.

As illustrated in FIG. 7, the first waste-collector's terminal device 30 is comprised of a controller 31, a radio-signal transceiver 32, a display unit 33, a data input device 34, a data memory 35, and an image reader 36.

The controller 31 is comprised of a central processing unit 31A and a memory 31B.

The memory 31B is comprised of a semiconductor memory such as a read only memory (ROM), a random access memory (RAM) or an IC memory card, or a storage device such as a flexible disc, a hard disc or an optic magnetic disc.

The memory 31B stores therein a program for controlling the central processing unit 31A. The central processing unit 31A reads the program out of the memory 31B, and executes the program. Thus, the central processing unit 31A operates in accordance with the program stored in the memory 31B.

The controller 31 is electrically connected to the radio-signal transceiver 32, the display unit 33, the data input device 34, the data memory 35 and the image reader 36, and controls operation of them.

The radio-signal transceiver 32 is connected to the network 1. The first waste-collector's terminal device 30 transmits radio-signals to the host server 10 through the radio-signal transceiver 32 and the network 1, and receives radio-signals from the host server 10 through the radio-signal transceiver 32 and the network 1.

The display unit 33 displays data input into the first waste-collector's terminal device 30 by a user through the data input device 34 and data received from the host server 10. For instance, the display unit 33 is comprised of a cathode ray tube (CRT), a liquid crystal display (LCD) device or an organic electroluminescence (EL) display.

A user inputs data into the first waste-collector's terminal device 30 through the data input device 34. For instance, the data input device 34 is comprised of a keyboard including a plurality of keys.

The data memory 35 stores various data therein.

For instance, the data memory 35 is comprised of a semiconductor memory such as a read only memory (ROM), a random access memory (RAM) or an IC memory card, or a storage device such as a flexible disc, a hard disc or an optic magnetic disc.

The image reader 36 reads image data. For instance, the image reader 36 is comprised of a camera taking a still or moving picture, or a scanner reading a still picture.

The second waste-collector's terminal device 40 is operated by the waste-collector 300, and is placed at a site Pt2 in which the waste-collector 300 stocks collected wastes, to collect data relating to waste dumped by the waste-dumper 200.

For instance, the second waste-collector's terminal device 40 is comprised of a desk-top type personal computer, or a mobile terminal device such as a cellular phone capable of making communication with the network 1, a terminal of a personal handy-phone system (PHS), a personal digital assistant (PDA) or a note-book type personal computer.

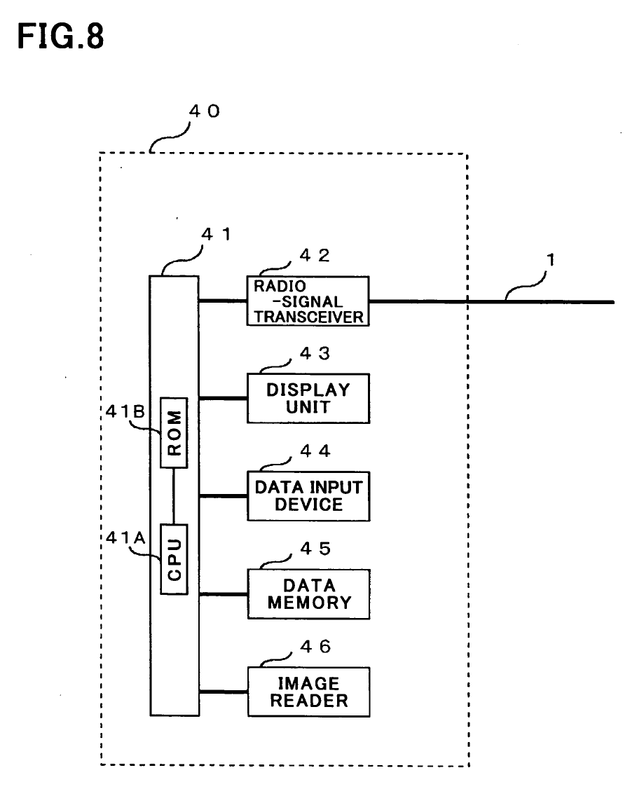

FIG. 8 is a block diagram of the second waste-collector's terminal device 40 in the first embodiment.

As illustrated in FIG. 8, the second waste-collector's terminal device 40 is comprised of a controller 41, a radio-signal transceiver 42, a display unit 43, a data input device 44, a data memory 45, and an image reader 46.

The controller 41 is comprised of a central processing unit 41A and a memory 41B.

The memory 41B is comprised of a semiconductor memory such as a read only memory (ROM), a random access memory (RAM) or an IC memory card, or a storage device such as a flexible disc, a hard disc or an optic magnetic disc.

The memory 41B stores therein a program for controlling the central processing unit 41A. The central processing unit 41A reads the program out of the memory 41B, and executes the program. Thus, the central processing unit 41A operates in accordance with the program stored in the memory 41B.

The controller 41 is electrically connected to the radio-signal transceiver 42, the display unit 43, the data input device 44, the data memory 45 and the image reader 46, and controls operation of them.

The radio-signal transceiver 42 is connected to the network 1. The second waste-collector's terminal device 40 transmits radio-signals to the host server 10 through the radio-signal transceiver 42 and the network 1, and receives radio-signals from the host server 10 through the radio-signal transceiver 42 and the network 1.

The display unit 43 displays data input into the second waste-collector's terminal device 40 by a user through the data input device 44 and data received from the host server 10. For instance, the display unit 43 is comprised of a cathode ray tube (CRT), a liquid crystal display (LCD) device or an organic electroluminescence (EL) display.

A user inputs data into the second waste-collector's terminal device 40 through the data input device 44. For instance, the data input device 44 is comprised of a keyboard including a plurality of keys.

The data memory 45 stores various data therein.

For instance, the data memory 45 is comprised of a semiconductor memory such as a read only memory (ROM), a random access memory (RAM) or an IC memory card, or a storage device such as a flexible disc, a hard disc or an optic magnetic disc.

The image reader 46 reads image data. For instance, the image reader 46 is comprised of a camera taking a still or moving picture, or a scanner reading a still picture.

The waste-reuser's terminal device 50 is operated by the waste-reuser 400, and is placed at a site Pt3 in which the waste-reuser 400 stocks reusable products and parts carried from the waste-collector 300 and further extracts reusable parts out of wastes, to collect data relating to waste carried from the waste-collector 300.

For instance, the waste-reuser's terminal device 50 is comprised of a desk-top type personal computer, or a mobile terminal device such as a cellular phone capable of making communication with the network 1, a terminal of a personal handy-phone system (PHS), a personal digital assistant (PDA) or a note-book type personal computer.

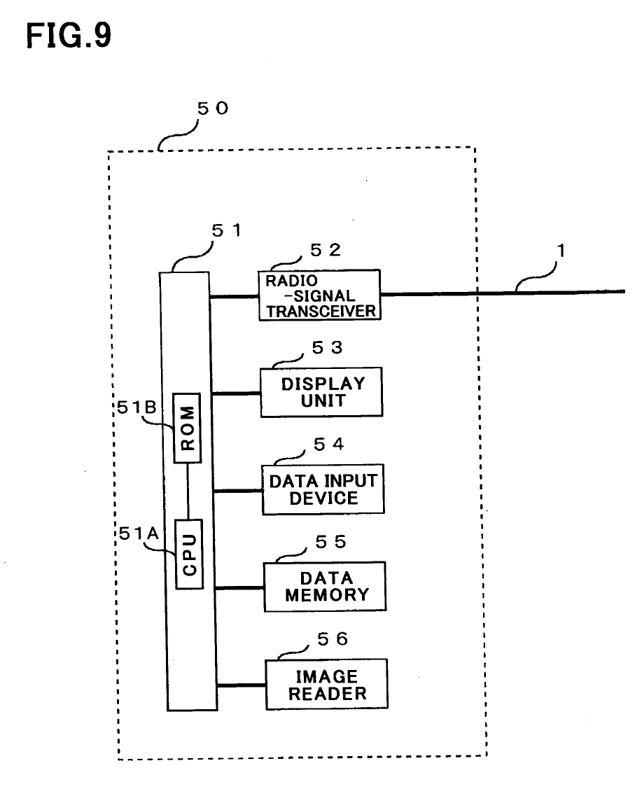

FIG. 9 is a block diagram of the waste-reuser's terminal device 50 in the first embodiment.

As illustrated in FIG. 9, the waste-reuser's terminal device 50 is comprised of a controller 51, a radio-signal transceiver 52, a display unit 53, a data input device 54, a data memory 55, and an image reader 56.

The controller 51 is comprised of a central processing unit 51A and a memory 51B.

The memory 51B is comprised of a semiconductor memory such as a read only memory (ROM), a random access memory (RAM) or an IC memory card, or a storage device such as a flexible disc, a hard disc or an optic magnetic disc.

The memory 51B stores therein a program for controlling the central processing unit 51A. The central processing unit 51A reads the program out of the memory 51B, and executes the program. Thus, the central processing unit 51A operates in accordance with the program stored in the memory 51B.

The controller 51 is electrically connected to the radio-signal transceiver 52, the display unit 53, the data input device 54, the data memory 55 and the image reader 56, and controls operation of them.

The radio-signal transceiver 52 is connected to the network 1. The waste-reuser's terminal device 50 transmits radio-signals to the host server 10 through the radio-signal transceiver 52 and the network 1, and receives radio-signals from the host server 10 through the radio-signal transceiver 52 and the network 1.

The display unit 53 displays data input into the waste-reuser's terminal device 50 by a user through the data input device 54 and data received from the host server 10. For instance, the display unit 53 is comprised of a cathode ray tube (CRT), a liquid crystal display (LCD) device or an organic electroluminescence (EL) display.

A user inputs data into the waste-reuser's terminal device 50 through the data input device 54. For instance, the data input device 54 is comprised of a keyboard including a plurality of keys.

The data memory 55 stores various data therein.

For instance, the data memory 55 is comprised of a semiconductor memory such as a read only memory (ROM), a random access memory (RAM) or an IC memory card, or a storage device such as a flexible disc, a hard disc or an optic magnetic disc.

The image reader 56 reads image data. For instance, the image reader 56 is comprised of a camera taking a still or moving picture, or a scanner reading a still picture.

The waste-recycler's terminal device 60 is operated by the waste-recycler 500, and is placed at a site Pt4 in which the waste-recycler 500 stocks recyclable products and parts carried from the waste-collector 300 and the waste-reuser 400, and further extracts recyclable parts out of wastes, to collect data relating to waste carried from the waste-collector 300 and the waste-reuser 400.

For instance, the waste-recycler's terminal device 60 is comprised of a desk-top type personal computer, or a mobile terminal device such as a cellular phone capable of making communication with the network 1, a terminal of a personal handy-phone system (PHS), a personal digital assistant (PDA) or a note-book type personal computer.

FIG. 10 is a block diagram of the waste-recycler's terminal device 60 in the first embodiment.

As illustrated in FIG. 10, the waste-recycler's terminal device 60 is comprised of a controller 61, a radio-signal transceiver 62, a display unit 63, a data input device 64, a data memory 65, and an image reader 66.

The controller 61 is comprised of a central processing unit 61A and a memory 61B.

The memory 61B is comprised of a semiconductor memory such as a read only memory (ROM), a random access memory (RAM) or an IC memory card, or a storage device such as a flexible disc, a hard disc or an optic magnetic disc.

The memory 61B stores therein a program for controlling the central processing unit 61A. The central processing unit 61A reads the program out of the memory 61B, and executes the program. Thus, the central processing unit 61A operates in accordance with the program stored in the memory 61B.

The controller 61 is electrically connected to the radio-signal transceiver 62, the display unit 0.63, the data input device 64, the data memory 65 and the image reader 66, and controls operation of them.

The radio-signal transceiver 62 is connected to the network 1. The waste-recycler's terminal device 60 transmits radio-signals to the host server 10 through the radio-signal transceiver 62 and the network 1, and receives radio-signals from the host server 10 through the radio-signal transceiver 62 and the network 1.

The display unit 63 displays data input into the waste-recycler's terminal device 60 by a user through the data input device 64 and data received from the host server 10. For instance, the display unit 63 is comprised of a cathode ray tube (CRT), a liquid crystal display (LCD) device or an organic electroluminescence (EL) display.

A user inputs data into the waste-recycler's terminal device 60 through the data input device 64. For instance, the data input device 64 is comprised of a keyboard including a plurality of keys.

The data memory 65 stores various data therein.

For instance, the data memory 65 is comprised of a semiconductor memory such as a read only memory (ROM), a random access memory (RAM) or an IC memory card, or a storage device such as a flexible disc, a hard disc or an optic magnetic disc.

The image reader 66 reads image data. For instance, the image reader 66 is comprised of a camera taking a still or moving picture, or a scanner reading a still picture.

The manufacturer's terminal device 70 is operated by the manufacturer 100, and is placed at a site Pt5 in which the manufacturer 100 manufactures products.

For instance, the manufacturer's terminal device 70 is comprised of a desk-top type personal computer, or a mobile terminal device such as a cellular phone capable of making communication with the network 1, a terminal of a personal handy-phone system (PHS), a personal digital assistant (PDA) or a note-book type personal computer.

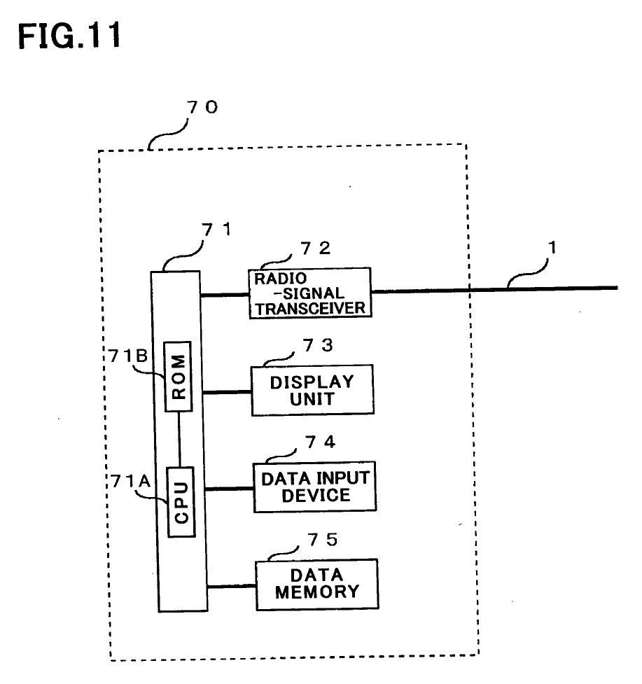

FIG. 11 is a block diagram of the manufacturer's terminal device 70 in the first embodiment.

As illustrated in FIG. 11, the manufacturer's terminal device 70 is comprised of a controller 71, a radio-signal transceiver 72, a display unit 73, a data input device 74 and a data memory 75.

The controller 71 is comprised of a central processing unit 71A and a memory 71B.

The memory 71B is comprised of a semiconductor memory such as a read only memory (ROM), a random access memory (RAM) or an IC memory card, or a storage device such as a flexible disc, a hard disc or an optic magnetic disc.

The memory 71B stores therein a program for controlling the central processing unit 71A. The central processing unit 71A reads the program out of the memory 71B, and executes the program. Thus, the central processing unit 71A operates in accordance with the program stored in the memory 71B.

The controller 71 is electrically connected to the radio-signal transceiver 72, the display unit 73, the data input device 74 and the data memory 75, and controls operation of them.

The radio-signal transceiver 72 is connected to the network 1. The manufacturer's terminal device 70 transmits radio-signals to the host server 10 through the radio-signal transceiver 72 and the network 1, and receives radio-signals from the host server 10 through the radio-signal transceiver 72 and the network 1.

The display unit 73 displays data input into the manufacturer's terminal device 70 by a user through the data input device 74 and data received from the host server 10. For instance, the display unit 73 is comprised of a cathode ray tube (CRT), a liquid crystal display (LCD) device or an organic electroluminescence (EL) display.

A user inputs data into the manufacturer's terminal device 70 through the data input device 74. For instance, the data input device 74 is comprised of a keyboard including a plurality of keys.

The data memory 75 stores various data therein.

For instance, the data memory 75 is comprised of a semiconductor memory such as a read only memory (ROM), a random access memory (RAM) or an IC memory card, or a storage device such as a flexible disc, a hard disc or an optic magnetic disc.

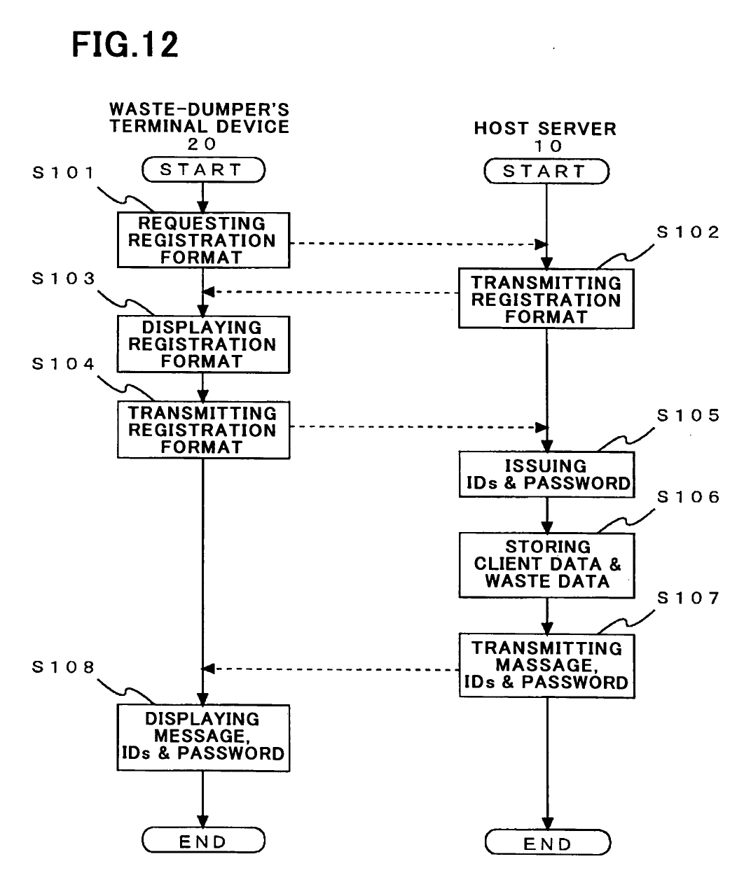

FIG. 12 is a flow-chart showing steps to be carried out when the waste-dumper 200 makes registration of his/her waste in the system in accordance with the first embodiment of the present invention.

Hereinbelow is explained waste-registration steps to be carried out between the waste-dumper 20 and the host server 10.

First, the waste-dumper's terminal device 20 transmits a request to the host server 10 through the radio-signal transceiver 22 to transmit a format for making registration for dumping wastes, in step S101.

On receipt of the request from the waste-dumper's terminal device 20, the host server 10 transmits a registration form stored in the data memory 15, to the waste-dumper's terminal device 20 through the radio-signal transceiver 12, in step S102.

On receipt of the registration format through the radio-signal transceiver 22, the display unit 23 displays the received registration format, in step S103.

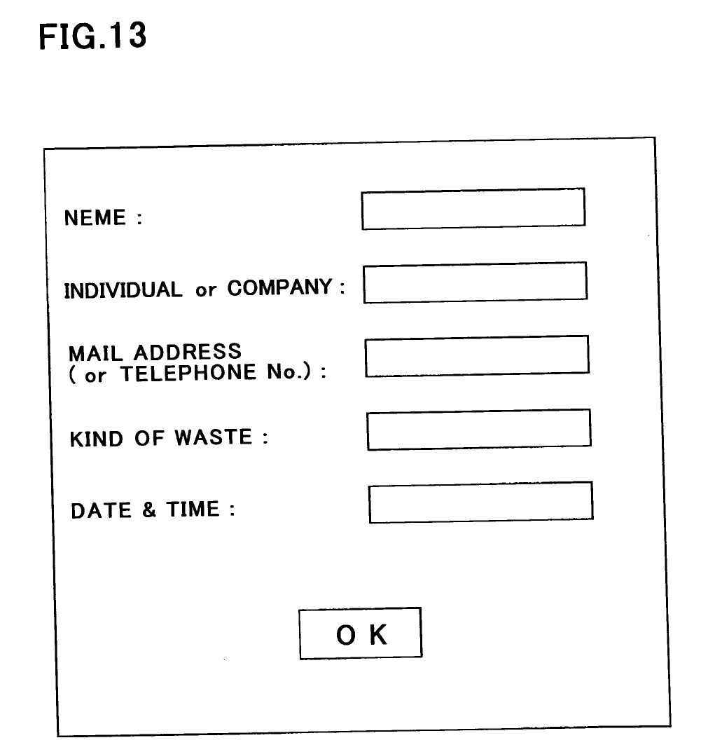

FIG. 13 illustrates an example of the registration format displayed in the display unit 23.

As illustrated in FIG. 13, the registration format has columns through which a name of a waste-dumper, indication as to whether a waste-dumper is an individual or a company, a mail address, a telephone number or an address, waste to be dumped, a date and time at which a waste-dumper wants his/her waste to be collected are input. The columns illustrated in FIG. 13 are just examples. The registration format may have other columns through which other data is input.

The waste-dumper inputs necessary data to the registration format through the data input device 24. After the columns are filled with data, the waste-dumper's terminal device 20 transmits the registration format to the host server 10 through the radio-signal transceiver 22, in step S104.

On receipt of the registration format through the radio-signal transceiver 12 from the waste-dumper's terminal device 20, the controller 11 issues a waste-dumper ID for identifying the waste-dumper among a lot of waste-dumpers, a password used by the waste-dumper to make access to data relating to his/her waste, a waste ID for identifying his/her waste among a lot of wastes, in step S105.

The controller 11 may check data indicative of a schedule of the waste-collector 300, stored in the data memory 15, and may determine a plurality of dates and times at which the waste is to be collected, in accordance with the schedule and a date and time at which the waste-dumper wants his/her waste to be collected.

The controller 11 may further check a fare list indicative of fares for collecting wastes, stored in the data memory 15, and may calculate a fare for collecting the waste, in accordance with the fare list and the waste dumped by the waste-dumper.

Then, the controller 11 stores the data input to the registration format, the password and the waste ID into the client data memory 16 as client data in association with the waste-dumper ID. Furthermore, the controller 11 stores the waste ID into the administration data memory 17 as waste data, in step S106.

Then, the host server 10 transmits the waste-dumper ID, the waste ID and the password to the waste-dumper's terminal device 20 together with a message that the registration was successfully made, through the radio-signal transceiver 12, in step S107.

On receipt of the waste-dumper ID, the waste ID, the password and the message through the radio-signal transceiver 22, the display unit 23 displays them, in step S108, to ensure the waste-dumper to confirm the received data.

The message transmitted to the waste-dumper's terminal device 20 from the host server 10 may include a list of dates and times at which the waste is to be collected, and a fare for collecting the waste.

Thus, the registration of waste is completed.

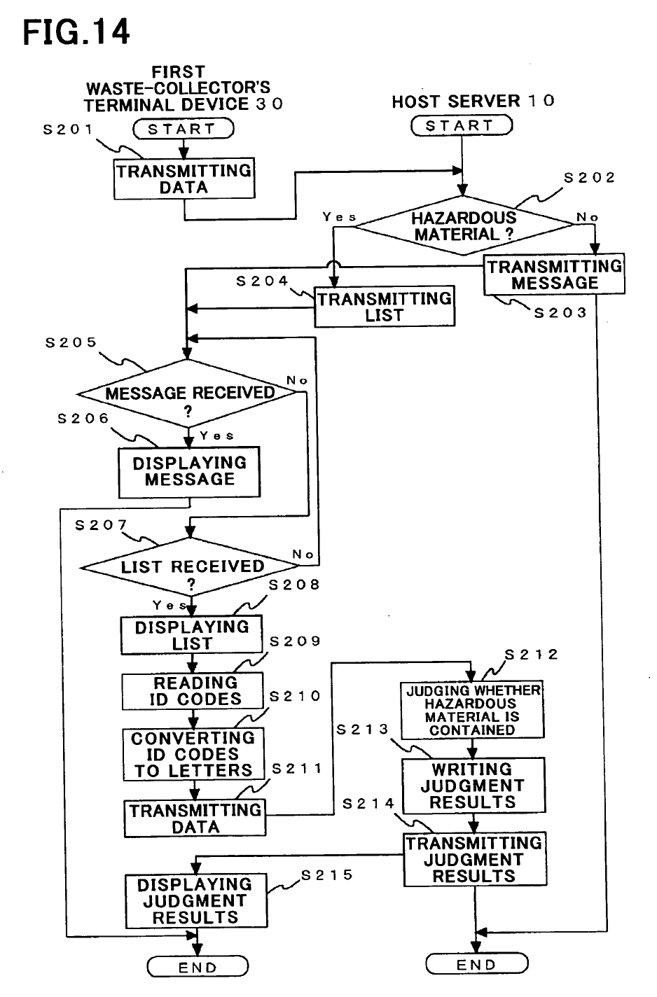

FIG. 14 is a flow-chart showing steps to be carried out when data indicative of hazardous material is transmitted between the first waste-collector's terminal device 30 and the host server 10 in the system in accordance with the first embodiment of the present invention. Hereinbelow are explained steps for carrying out judgment as to whether waste contains hazardous material.

It is assumed that waste which the waste-dumper 200 wants to be carried is stocked in the site Pt1. The waste-collector 300 moves to the site Pt1, ad checks whether waste the waste-collector 300 is going to carry contains hazardous material, as follows.

First, the waste-collector 300 inputs data about waste to be carried (or a tradename of a product as the waste), a product number of the waste, and a date at which the product was manufactured, into the first waste-collector's terminal device 30 through the data input device 34. The first waste-collector's terminal device 30 transmits the input data into the host server 10 through the radio-signal transceiver 32, in step S201.

On receipt of the data from the first waste-collector's terminal device 30 through the radio-signal transceiver 12, the host server 10 refers to a product database stored in the data memory 15, and judges whether waste identified by the received data contains hazardous material, in step S202.

The product database stored in the data memory 15 includes data indicative of parts constituting each of products, and data indicative of whether each of the parts contains hazardous material which is prohibited to carry.

If the host server 10 judges that the waste does not contain hazardous material (NO in step S202), the host server 10 transmits a message that a test as to whether the waste contains hazardous material ends, to the first waste-collector's terminal device 30 through the radio-signal transceiver 12, in step S203.

If the host server 10 judges that the waste contains hazardous material (YES in step S202), the host server 10 transmits a list indicating parts judged to contain hazardous material among parts constituting the waste, to the first waste-collector's terminal device 30 through the radio-signal transceiver 12, in step S204.

Then, the controller 31 of the first waste-collector's terminal device 30 judges whether the first waste-collector's terminal device 30 receives the above-mentioned message from the host server 10, in step S205.

If the first waste-collector's terminal device 30 received the message from the host sever 10 (YES in step S205), the display unit 33 displays the received message, in step S206. The waste-collector 300 confirms the message displayed in the display unit 33, and ends the test as to whether the waste stocked in the site Pt1 contains hazardous material.

If the first waste-collector's terminal device 30 did not receive the message from the host sever 10 (NO in step S205), the controller 31 judges whether the first waste-collector's terminal device 30 received the above-mentioned list indicating parts judged to contain hazardous material, in step S207.

If the first waste-collector's terminal device 30 did not receive the list from the host sever 10 (NO in step S207), the controller 31 repeats judging whether the first waste-collector's terminal device 30 receives the above-mentioned message from the host server 10 (step S205).

If the first waste-collector's terminal device 30 received the list from the host sever 10 (YES in step S207), the display unit 33 displays the received list, in step S208.

Then, the waste-collector 300 reads ID codes of parts indicated in the list, by means of the image reader 36 of the first waste-collector's terminal device 30, in step S209.

Herein, the ID codes indicate codes for identifying parts constituting the waste. For instance, the ID codes may be comprised of names of the waste or parts, a particular arrangement of characters, symbols or a bar code. The ID codes may be indicated at a surface of the waste or parts, or may be indicated in a paper such as an instruction manual of a product (the waste) or in the form of electronic data.

The ID codes read through the image reader 36 are temporarily stored in the data memory 35.

Then, the controller 31 compares the ID codes to data stored in the data memory 35 and used for identification of letters, and identifies letters indicated by the ID codes. Thus, the controller 31 converts the ID codes which are in the form of image data, into letters, in step S210.

Then, the first waste-collector's terminal device 30 transmits the ID codes which are now in the form of letters, to the host server 10 as data indicative of hazardous material through the radio-signal transceiver 32, in step S211.

On receipt of the data from the host server 10 through the radio-signal transceiver 12, the controller 11 of the host server 10 refers to hazardous material database stored in the data memory 15, and judges whether the waste indicated by the received data contains hazardous material, in step S212.

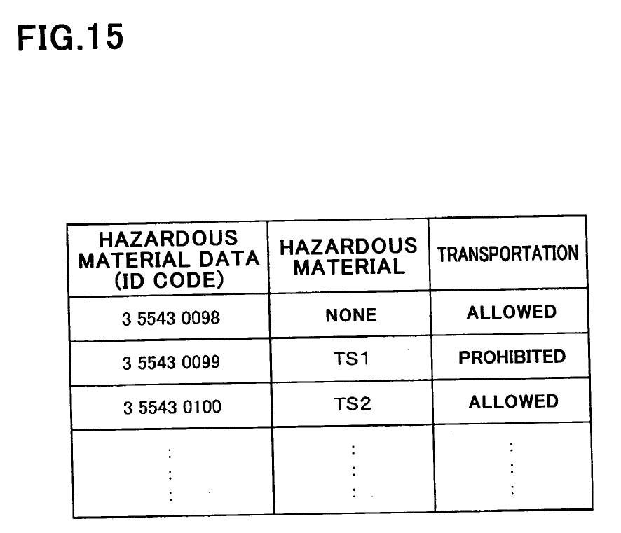

FIG. 15 illustrates the hazardous material database stored in the data memory 15 in the first embodiment.

As illustrated in FIG. 15, the hazardous material database indicates hazardous material contained each of products and parts identified by hazardous material data or an ID code, and indication as to whether products or parts containing the hazardous material are allowed or prohibited to be carried in a law. For instance, a part identified with an ID code “355430099” contains hazardous material “TS1”, and is prohibited to carry.

The controller 11 writes result of judgment as to whether hazardous material is contained, into a column “judgment result about hazardous material” in waste administration data identified with the waste ID in the administration data memory 17, in step S213.

Then, the host server 10 transmits the result of judgment as to whether the waste contains hazardous material, to the first waste-collector's terminal device 30 through the radio-signal transceiver 12, in step S214.

On receipt of the judgment results from the host server 10, the display unit 33 of the first waste-collector's terminal device 30 displays the received judgment results, in step S215.

Confirming the judgment results displayed in the display unit 33, the waste-collector 300 removes parts containing hazardous material and hence prohibited to carry, out of the waste. Then, the waste-collector 300 makes image data of the rest of the waste in such a manner as mentioned later. If the waste does not contain parts containing hazardous material and hence prohibited to carry, the waste-collector 300 makes image data of the waste as it is.

In the first embodiment, the ID codes are read out by reading images of the ID codes attached to the waste or parts. As an alternative, the waste-collector 300 may input letter data indicated by the ID code, into the first waste-collector's terminal device 30 through the data input device 34.

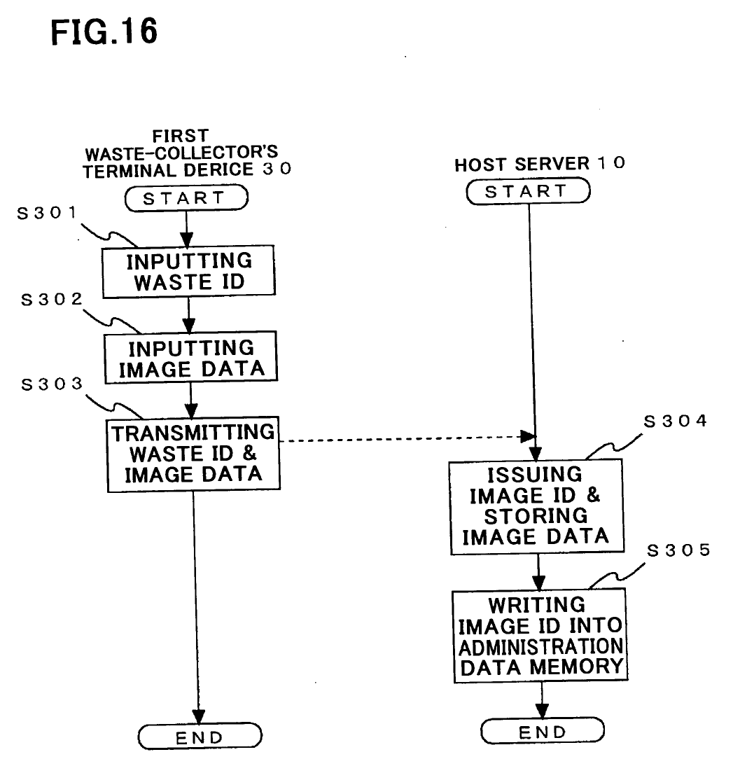

FIG. 16 is a flow-chart showing steps to be carried out when image data of waste is made by the first waste-collector's terminal device 30. Hereinbelow are explained steps of producing image data of waste, with reference to FIG. 16.

First, the waste-collector 300 inputs a waste ID of waste to be collected, through the data input device 34, in step S301. The input waste ID is temporarily stored in the data memory 35.

Then, the waste-collector 300 inputs image data of the waste through the image reader 36 of the first waste-collector's terminal device 30, in step S302. For instance, the waste-collector 300 takes pictures of the waste by means of the image reader 36.

Then, the first waste-collector's terminal device 30 transmits the input image data of the waste to the host server 10 together with the waste ID associated with the waste, in step S303.

On receipt of the image data together with the waste ID from the first waste-collector's terminal device 30 through the radio-signal transceiver 12, the controller 11 of the host server 10 issues an image ID for identifying the received image data. The controller 11 stores the received image data in the administration data memory 17 in association with the issued image ID, in step S304.

Furthermore, the controller 11 stores the image ID of the waste into the waste administration data identified with the waste ID received together with the image data, in the administration data memory 17, in step S305.

The image data of waste is made in the above-mentioned way.

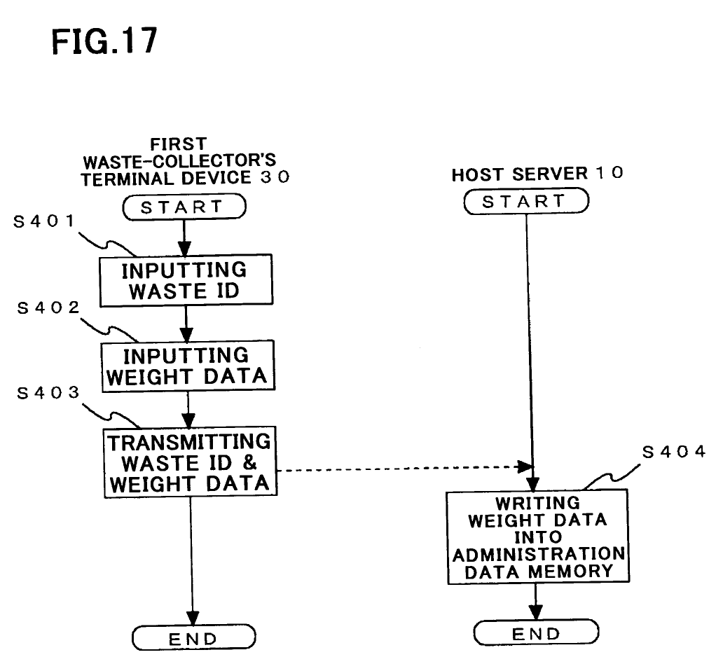

FIG. 17 is a flow-chart showing steps to be carried out when weight data of waste is made by the first waste-collector's terminal device 30. Hereinbelow are explained steps of producing weight data of waste, with reference to FIG. 17.

First, the waste-collector 300 inputs a waste ID of waste to be collected, through the data input device 34, in step S401. The input waste ID is temporarily stored in the data memory 35.

Then, the waste-collector 300 measures a weight of the waste by means of a weighing instrument (not illustrated). Then, the waste-collector 300 inputs a weight into the controller 31 through the data input device 34, in step S402. The first waste-collector's terminal device 30 may be designed to make communication with a weighting instrument such that the weighing instrument can directly input a weight of the waste into the first waste-collector's terminal device 30.

Then, the first waste-collector's terminal device 30 transmits the input weight data Wa to the host server 10 together with the waste ID through the radio-signal transceiver 32, in step S403.

On receipt of the weight data Wa together with the waste ID from the first waste-collector's terminal device 30 through the radio-signal transceiver 12, the controller 11 of the host server 10 stores the received weight data Wa into the administration data memory 17 in association with the waste ID, in step S404.

The weight data Wa of the waste is made in the above-mentioned way.

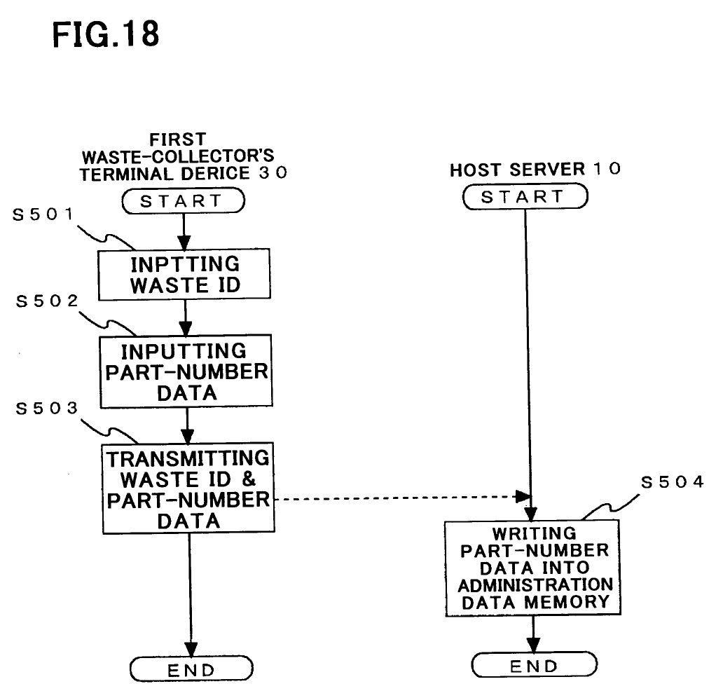

FIG. 18 is a flow-chart showing steps to be carried out when data indicative of a number of parts constituting waste (hereinbelow, referred to as “part-number data”) is made by the first waste-collector's terminal device 30. Hereinbelow are explained steps of producing part-number data of waste, with reference to FIG. 18.

First, the waste-collector 300 inputs a waste ID of waste to be collected, through the data input device 34, in step S501. The input waste ID is temporarily stored in the data memory 35.

Then, the waste-collector 300 counts parts of the waste. Then, the waste-collector 300 inputs the part-number data Na into the controller 31 through the data input device 34, in step S502.

Then, the first waste-collector's terminal device 30 transmits the part-number data Na to the host server 10 together with the waste ID through the radio-signal transceiver 32, in step S503.

On receipt of the part-number data Na together with the waste ID from the first waste-collector's terminal device 30 through the radio-signal transceiver 12, the controller 11 of the host server 10 stores the received part-number data Na into the administration data memory 17 in association with the waste ID, in step S504.

The part-number data Na of the waste is made in the above-mentioned way.

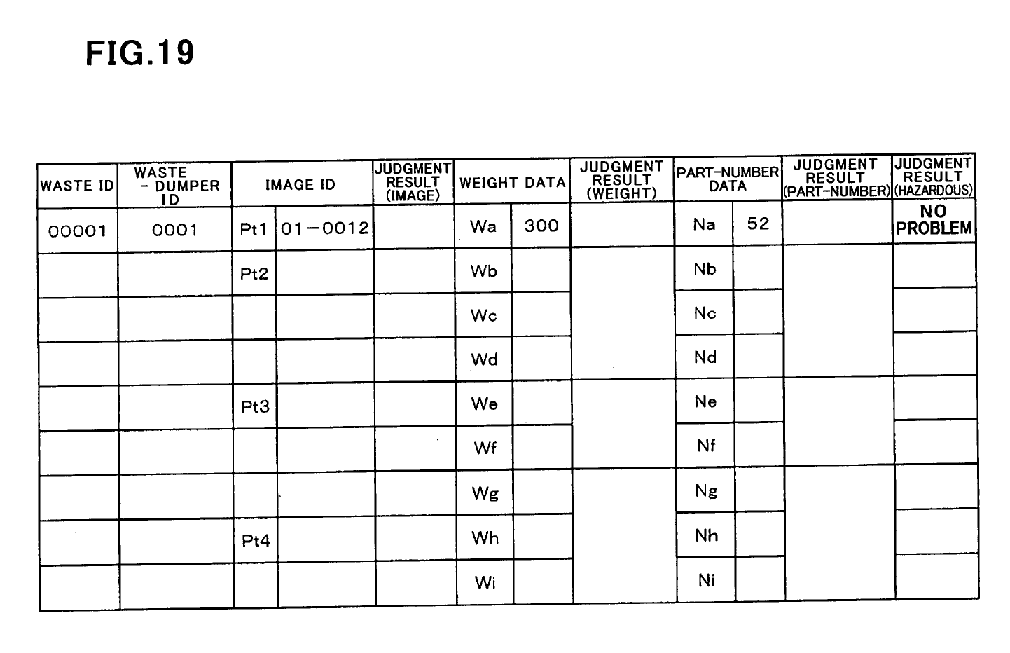

FIG. 19 illustrates an example of the waste administration data stored in the administration data memory 17, observed after the image data, the weight data and the part-number data all of which were collected at the site Pt1 are stored into the waste administration data.

The waste administration data illustrated in FIG. 19 relates to waste identified with the waste ID “00001”. The waste id indicated as being dumped by a waste-dumper identified with the waste-dumper ID “0001”.

In a column of the image ID, the image data of waste made at the site Pt1 and identified with the image ID “01-0012” is written by the controller 11.

In a column of the weight data Wa, the weight data Wa “300 (kg)” indicative of a weight of the waste having been measured at the site Pt1 is written by the controller 11.

In a column of the part-number data Na, the part-number data Na “52” indicative of a number of parts constituting the waste, having been counted at the site Pt1 is written by the controller 11.

In a column of the judgment result as to whether the waste contains hazardous material, the result “NO” is written by the controller 11.

The hazardous material data, the image data, the weight data and the part-number data of the waste collected at the site Pt1 are made in the above-mentioned ways. Then, the waste-collector 300 transmits a message that a test of the waste collected at the site Pt1 has been completed, to the host server 10.

After having input the above-mentioned data into the first waste-collector's terminal device 30, the waste-collector 300 carries the waste to the site Pt2. Then, the waste-collector 300 transmits a message that the waste was carried to the site Pt2 from the Pt1, to the host server 10.

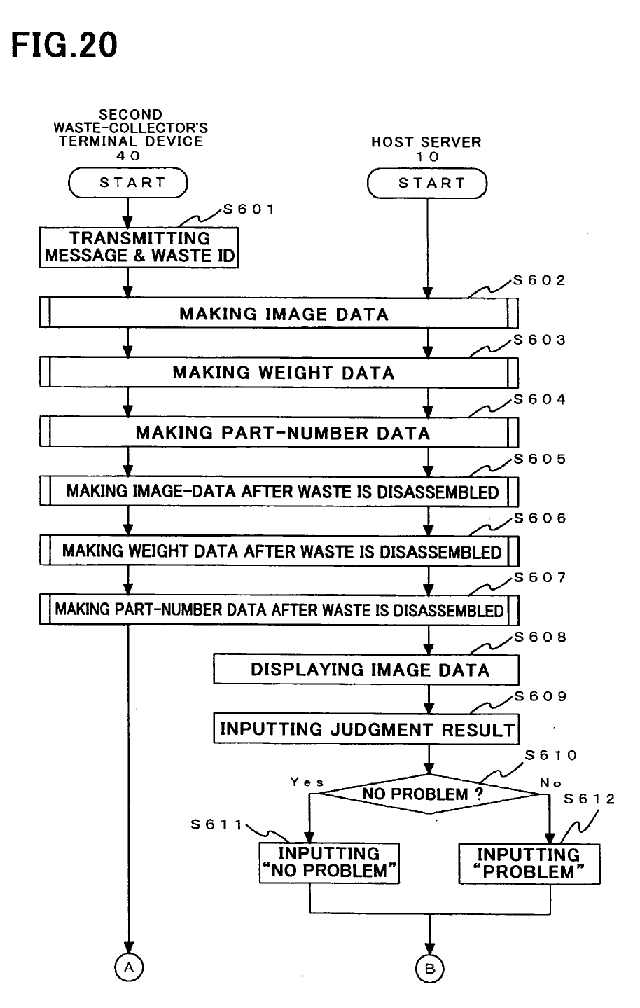

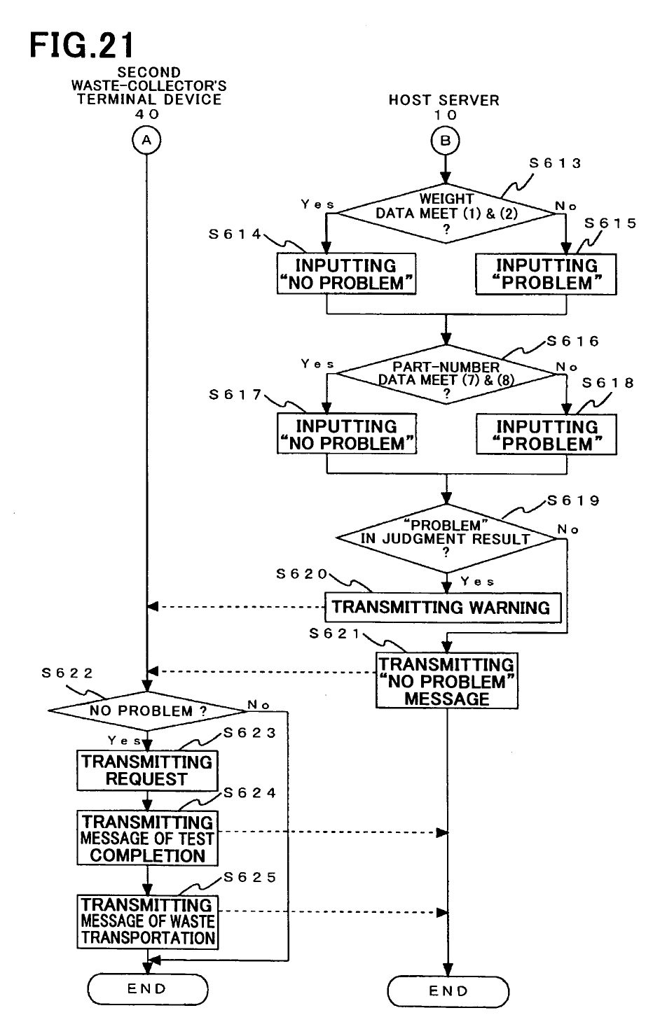

FIGS. 20 and 21 are flow-charts showing steps to be carried out when it is judged at the site Pt2 whether waste is illegally dumped.

Hereinbelow are explained steps carried out at the site Pt2 for judging whether waste is illegally dumped, with reference to FIGS. 20 and 21.

When the waste arrives at the site Pt2 from the Pt1, the waste-collector 300 transmits a message that the waste was carried to the site Pt2, to the host server 10 together with the waste ID through the radio-signal transceiver 42 of the second waste-collector's terminal device 40, in step S601.

Then, the waste-collector 300 makes image data of the waste by means of the image reader 46 of the second waste-collector's terminal device 40, in step S602. The image data is made by the second waste-collector's terminal device 40, and then, is transmitted to the host server 10 together with the waste ID in the same steps as the steps illustrated in FIG. 16 to be carried out by the first waste-collector's terminal device 30.

Then, the waste-collector 300 weighs the waste at the site Pt2, in step S603. The weight data is made by the second waste-collector's terminal device 40, and then, is transmitted to the host server 10 together with the waste ID in the same steps as the steps illustrated in FIG. 17 to be carried out by the first waste-collector's terminal device 30. The thus obtained data indicative of a weight of the waste is referred to as weight data Wb.

Then, the waste-collector 300 counts parts constituting the waste, at the site Pt2, in step S604. The part-number data is made by the second waste-collector's terminal device 40, and then, is transmitted to the host server 10 together with the waste ID in the same steps as the steps illustrated in FIG. 18 to be carried out by the first waste-collector's terminal device 30. The thus obtained data indicative of a number of parts constituting the waste is referred to as part-number data Nb.

Then, the waste-collector 300 disassembles the waste having been carried from the site Pt1, into parts, and groups the parts into parts reusable as they are and parts non-reusable because of failure and/or breakage. Herein, the reusable parts are referred to as firstly reusable parts.

Then, the waste-collector 300 takes pictures of the firstly reusable parts and the non-reusable parts by means of the image reader 46 of the second waste-collector's terminal device 40. The image data is transmitted to the host server 10 together with the waste ID in the same steps as the steps illustrated in FIG. 16 to be carried out by the first waste-collector's terminal device 30.

Then, the waste-collector 300 weighs the firstly reusable parts and the non-reusable parts at the site Pt2 by means of a weighing instrument, in step S606.

The weight data is made by the second waste-collector's terminal device 40, and then, is transmitted to the host server 10 together with the waste ID in the same steps as the steps illustrated in FIG. 17 to be carried out by the first waste-collector's terminal device 30. The thus obtained data indicative of a weight of the reusable parts is referred to as weight data Wc, and the data indicative of a weight of the non-reusable parts is referred to as weight data Wd.

Then, the waste-collector 300 counts parts constituting the waste, at the site Pt2, in step S607. The part-number data is made by the second waste-collector's terminal device 40, and then, is transmitted to the host server 10 together with the waste ID in the same steps as the steps illustrated in FIG. 18 to be carried out by the first waste-collector's terminal device 30. The thus obtained data indicative of a number of the reusable parts is referred to as part-number data Nc, and the data indicative of a number of the non-reusable parts is referred to as part-number data Nd.

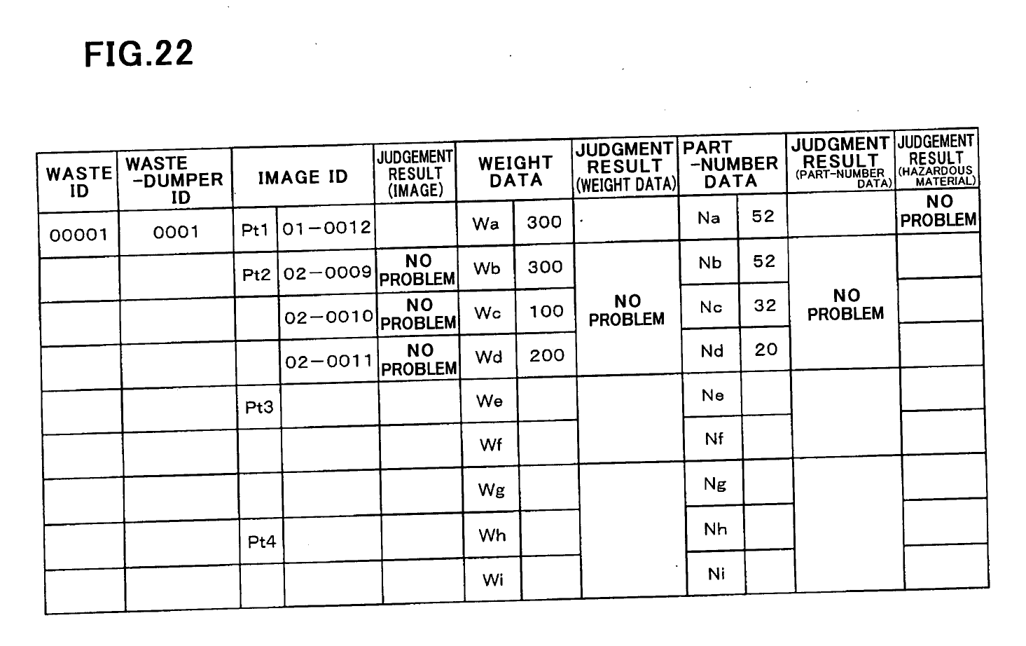

FIG. 22 illustrates an example of the waste administration data stored in the administration data memory 17, observed after the image data, the weight data and the part-number data all of which were collected at the site Pt2 before and after the waste was disassembled are stored into the waste administration data.

The waste administration data illustrated in FIG. 22 relates to waste identified with the waste ID “00001”.

The waste administration data includes the image data having been taken at the site Pt1 and identified with the image ID “01-0012”, the image data having been taken at the site Pt2 before disassembled and identified with the image ID “02-0009”, the image data of the reusable parts having been taken at the site Pt2 after disassembled and identified with the image ID “02-0010”, and the image data of the non-reusable parts having been taken at the site Pt2 after disassembled and identified with the image ID “02-0011”. These image data are written into the administration data memory 17 by the controller 11.

The waste administration data includes the weight data Wa having been taken at the site Pt1 and indicating “300 (kg)”, the weight data Wb having been taken at the site Pt2 before disassembled and indicating “300 (kg)”, the weight data Wc of the reusable parts having been taken at the site Pt2 after disassembled and indicating “100 (kg)”, and the weight data Wd of the non-reusable parts having been taken at the site Pt2 after disassembled and indicating “200 (kg)”. These weight data are written into the administration data memory 17 by the controller 11.

The waste administration data further includes the part-number data Na having been taken at the site Pt1 and indicating “52”, the part-number data Nb having been taken at the site Pt2 before disassembled and indicating “52”, the part-number data Nc of the reusable parts having been taken at the site Pt2 after disassembled and indicating “32”, and the part-number data Wd of the non-reusable parts having been taken at the site Pt2 after disassembled and indicating “20”. These part-number data are written into the administration data memory 17 by the controller 11.

Then, the controller 11 displays the above-mentioned image data having been collected at the sites Pt1 and Pt2, in the display unit 13, in step S608.

Viewing the image data displayed in the display unit 13, the system administrator judges whether the parts are lost or replaced before and after the waste was carried to the site Pt2 from the site Pt1, that is, whether the waste was illegally dumped while being carried to the site Pt2 from the site Pt1.

Further, viewing the image data displayed in the display unit 13, the system administrator judges whether the parts are lost or replaced before and after the waste was disassembled and grouped into parts in the site Pt2, that is, whether the waste was illegally dumped at the site Pt 2 while being disassembled and grouped into parts in the site Pt2.

Then, the system administrator inputs the result of judgment “No Problem” or “Problem” into the host server 10 through the data input device 14, in step S609.

If the result of judgment “No Problem” is input (YES in step S610), the controller 11 inputs “No Problem” into a column of judgment result of the image data in the waste administration data stored in the administration data memory 17, in step S611.

If the result of judgment “Problem” is input (NO in step S610), the controller 11 inputs “Problem” into a column of judgment result of the image data in the waste administration data stored in the administration data memory 17, in step S612.

Then, the controller 11 checks the weight data Wa, Wb, Wc and Wd to judge whether the waste is legally disposed of, in step S613.

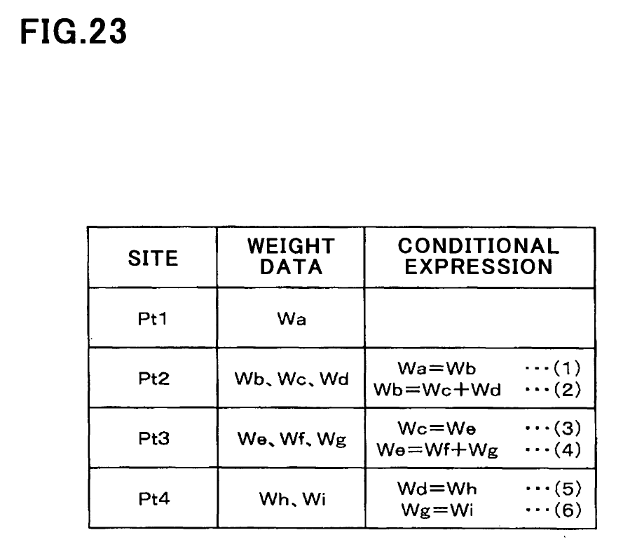

The judgment as to whether the waste is legally disposed of is made through the use of conditional expressions. FIG. 23 shows the conditional expressions used for judging whether the waste is legally disposed of, based on the weight data. Hereinbelow is explained the judgment with reference to FIG. 23.

As illustrated in FIG. 23, when the waste is stocked at the site Pt2, the controller 11 judges whether the weight data Wa, Wb, Wc and Wd meet the following conditional expressions (1) and (2).

Wa=Wb (1)

Wb=Wc+Wd (2)

The conditional expression (1) is used for judging whether a weight of the waste measured after the waste was carried to the site Pt2 from the Pt1 is reduced in comparison with a weight of the waste measured before the waste was carried to the site Pt2 from the Pt1. That is, it is judged in accordance with the conditional expression (1) whether the waste was illegally dumped while the waste was carried to the site Pt2 from the Pt1.

The conditional expression (2) is used for judging whether a weight of the waste measured after the waste was disassembled is reduced in comparison with a weight of the waste measured before the waste was disassembled. That is, it is judged in accordance with the conditional expression (2) whether the waste was illegally dumped while the waste was disassembled and grouped into the reusable and non-reusable parts.

If the controller 11 judges that the weight data stored in the administration data memory 17 meet the conditional expressions (1) and (2), that is, the controller 11 judges that the waste was not illegally dumped (YES in step S613), the controller 11 writes “No Problem” into a column of the judgment result of the weight data, in step S614.

If the controller 11 judges that the weight data stored in the administration data memory 17 do not meet the conditional expressions (1) and/or (2), that is, the controller 11 judges that the waste might be illegally dumped (NO in step S613), the controller 11 writes “Problem” into a column of the judgment result of the weight data, in step S615.

Then, the controller 11 checks the part-number data Na, Nb, Nc and Nd to judge whether the waste is legally disposed of, in step S616.

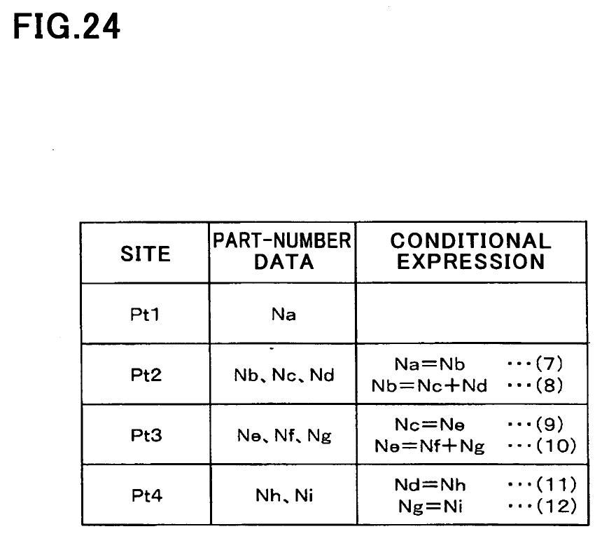

The judgment as to whether the waste is legally disposed of is made through the use of conditional expressions. FIG. 24 shows the conditional expressions used for judging whether the waste is legally disposed of, based on the part-number data. Hereinbelow is explained the judgment with reference to FIG. 24.

As illustrated in FIG. 24, when the waste is stocked at the site Pt2, the controller 11 judges whether the part-number data Na, Nb, Nc and Nd meet the following conditional expressions (7) and (8).

Na=Nb (7)

Nb=Nc+Nd (8)

The conditional expression (7) is used for judging whether a number of parts constituting the waste counted after the waste was carried to the site Pt2 from the Pt1 is reduced in comparison with a number of parts constituting the waste counted before the waste was carried to the site Pt2 from the Pt1. That is, it is judged in accordance with the conditional expression (7) whether the waste was illegally dumped while the waste was carried to the site Pt2 from the Pt1.

The conditional expression (8) is used for judging whether a number of parts constituting the waste counted after the waste was disassembled is reduced in comparison with a number of parts constituting the waste counted before the waste was disassembled. That is, it is judged in accordance with the conditional expression (8) whether the waste was illegally dumped while the waste was disassembled and grouped into the reusable and non-reusable parts.

If the controller 11 judges that the weight data stored in the administration data memory 17 meet the conditional expressions (7) and (8), that is, the controller 11 judges that the waste was not illegally dumped (YES in step S616), the controller 11 writes “No Problem” into a column of the judgment result of the part-number data, in step S617.

If the controller 11 judges that the weight data stored in the administration data memory 17 do not meet the conditional expressions (7) and/or (8), that is, the controller 11 judges that the waste might be illegally dumped (NO in step S616), the controller 11 writes “Problem” into a column of the judgment result of the weight data, in step S618.

Then, the controller 11 checks whether “Problem” is written in any columns of the judgment result in the waste administration data, in step S619.

When “Problem” is written in any one of columns of the judgment result in the waste administration data (YES in step S619), the controller 11 transmits a warning message to the second waste-collector's terminal device 40 to request the second waste-collector's terminal device 40 to temporally stop disposal of the waste, in step S620. For instance, the controller 11 transmits an e-mail to the second waste-collector's terminal device 40 through the radio-signal transceiver 12.

When “No Problem” is written in all of columns of the judgment result in the waste administration data (No in step S619), the controller 11 transmits a message of “No Problem” indicating that the waste was legally disposed of, to the second waste-collector's terminal device 40, in step S621.

The controller 41 of the second waste-collector's terminal device 40 judges whether a message of “No Problem” was received, in step S622.

If the controller 41 judges that a message of “Problem” was received (NO in step S622), the controller 41 ends the judgment process.

If the controller 41 judges that a message of “No Problem” was received for all of columns of the judgment result (YES in step S622), the controller 41 transmits a request of reusing or recycling the waste to the waste-reuser's terminal device 50 and the waste-recycler's terminal device 60, in step S623.

Then, the waste-collector 300 transmits a message that the test to the waste at the site Pt2 was completed, to the host server 10, in step S624.

Then, the waste-collector 300 carries the firstly reusable parts to the site Pt3 and the non-reusable parts to the site Pt4. The waste-collector 300 transmits a message that the firstly reusable parts and the non-reusable parts were carried to the sites Pt3 and Pt4, to the host server 10 through the second waste-collector's terminal device 40, in step S625.

Thus, the judgment carried out in the site Pt2 as to whether the waste is illegally dumped is completed.

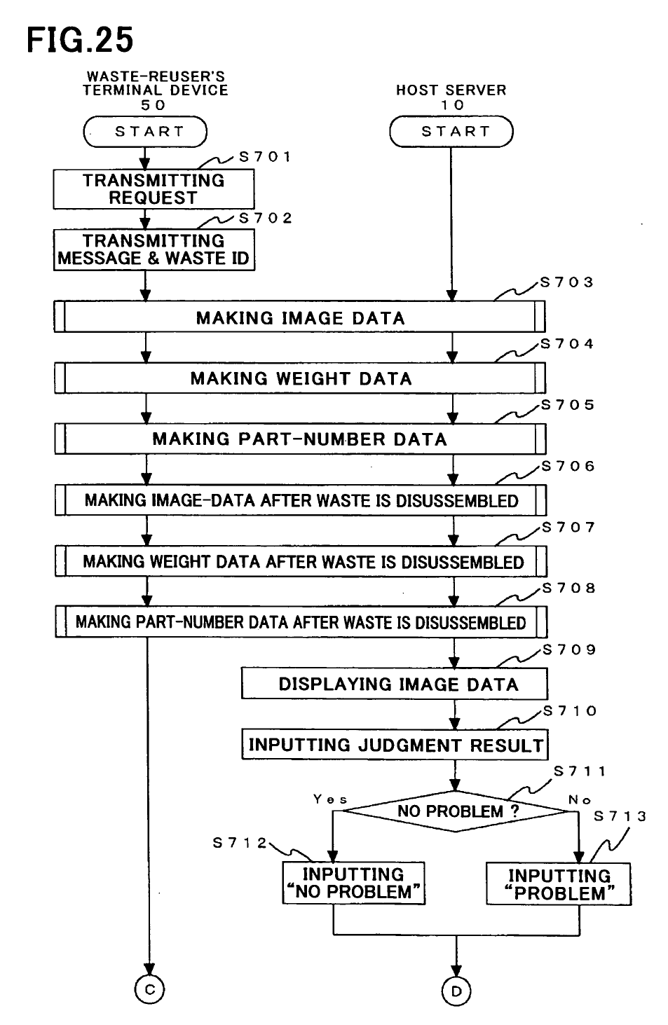

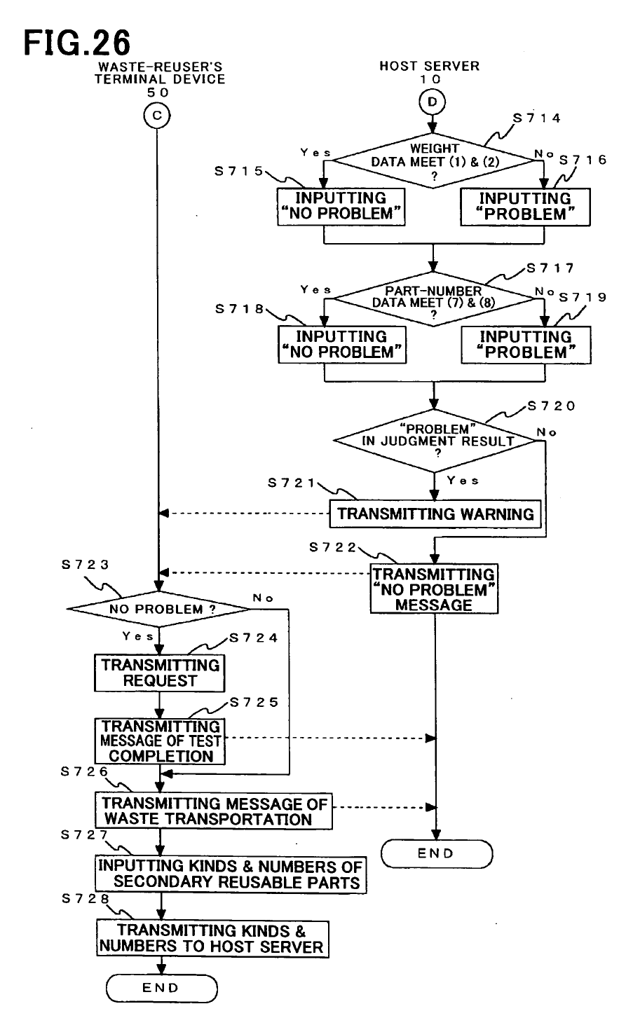

FIGS. 25 and 26 are flow-charts showing steps to be carried out when it is judged at the site Pt3 whether waste is illegally dumped.

Hereinbelow are explained steps carried out at the site Pt3 for judging whether waste is illegally dumped, with reference to FIGS. 25 and 26.

The waste-reuser's terminal device 50 receives a request of reusing waste, from the second waste-collector's terminal device 40, in step S701. The request includes the waste ID identifying the waste, that is, the firstly reusable parts.

When the waste arrives at the site Pt3 from the Pt2, the waste-reuser 400 transmits a message that the waste or the firstly reusable parts was carried to the site Pt3, to the host server 10 together with the waste ID through the radio-signal transceiver 52 of the waste-reuser's terminal device 50, in step S702.

Then, the waste-reuser 400 makes image data of the waste by means of the image reader 56 of the waste-reuser's terminal device 50, in step S703. The image data is made by the waste-reuser's terminal device 50, and then, is transmitted to the host server 10 together with the waste ID in the same steps as the steps illustrated in FIG. 16 to be carried out by the first waste-collector's terminal device 30.

Then, the waste-reuser 400 weighs the firstly reusable parts at the site Pt3, in step S704. The weight data is made by the waste-reuser's terminal device 50, and then, is transmitted to the host server 10 together with the waste ID in the same steps as the steps illustrated in FIG. 17 to be carried out by the first waste-collector's terminal device 30. The thus obtained data indicative of a weight of the firstly reusable parts is referred to as weight data We.

Then, the waste-reuser 400 counts the firstly reusable parts at the site Pt3, in step S705. The part-number data is made by the waste-reuser's terminal device 50, and then, is transmitted to the host server 10 together with the waste ID in the same steps as the steps illustrated in FIG. 18 to be carried out by the first waste-collector's terminal device 30. The thus obtained data indicative of a number of the firstly reusable parts is referred to as part-number data Ne.

Then, if necessary, the waste-reuser 400 disassembles the firstly reusable parts into parts, and groups the parts into parts reusable as they are and parts non-reusable because of failure and/or breakage. Herein, the reusable parts are referred to as secondary reusable parts.

Then, the waste-reuser 400 takes pictures of the secondly reusable arts and the non-reusable parts by means of the image reader 56 of the waste-reuser's terminal device 50, in step S706. The image data is transmitted to the host server 10 together with the waste ID in the same steps as the steps illustrated in FIG. 16 to be carried out by the first waste-collector's terminal device 30.

Then, the waste-reuser 400 weighs the secondary reusable parts and the non-reusable parts at the site Pt3 by means of a weighing instrument, in step S707.

The weight data is made by the waste-reuser's terminal device 50, and then, is transmitted to the host server 10 together with the waste ID in the same steps as the steps illustrated in FIG. 17 to be carried out by the first waste-collector's terminal device 30. The thus obtained data indicative of a weight of the secondary reusable parts is referred to as weight data Wf, and the data indicative of a weight of the non-reusable parts is referred to as weight data Wg.

Then, the waste-reuser 400 counts the secondary reusable parts and the non-reusable parts at the site Pt3, in step S708. The part-number data is made by the waste-reuser's terminal device 50, and then, is transmitted to the host server 10 together with the waste ID in the same steps as the steps illustrated in FIG. 18 to be carried out by the first waste-collector's terminal device 30. The thus obtained data indicative of a number of the secondary reusable parts is referred to as part-number data Nf, and the data indicative of a number of the non-reusable parts is referred to as part-number data Ng.

Then, the controller 11 displays the above-mentioned image data of the firstly reusable parts, the secondary reusable parts and the non-reusable parts, having been input at the sites Pt2 and Pt3, in the display unit 13, in step S709.

Viewing the image data of the firstly reusable parts, the secondary reusable parts and the non-reusable parts displayed in the display unit 13, the system administrator judges whether the parts are lost or replaced before and after the waste was carried to the site Pt3 from the site Pt2, that is, whether the waste was illegally dumped while being carried to the site Pt3 from the site Pt2.

Further, viewing the image data of the firstly reusable parts, the secondary reusable parts and the non-reusable parts displayed in the display unit 13, the system administrator judges whether the parts are lost or replaced before and after the waste was disassembled and grouped into parts in the site Pt3, that is, whether the waste was illegally dumped at the site Pt 3 while being disassembled and grouped into the secondary reusable and non-reusable parts in the site Pt3.

Then, the system administrator inputs the result of judgment “No Problem” or “Problem” into the host server 10 through the data input device 14, in step S710.

If the result of judgment “No Problem” is input (YES in step S711), the controller 11 inputs “No Problem” into a column of judgment result of the image data in the waste administration data stored in the administration data memory 17, in step S712.

If the result of judgment “Problem” is input (NO in step S711), the controller 11 inputs “Problem” into a column of judgment result of the image data in the waste administration data stored in the administration data memory 17, in step S713.

Then, the controller 11 checks the weight data Wc, We, Wf and Wg to judge whether the waste is legally disposed of, in step S714.

The judgment as to whether the waste is legally disposed of is made through the use of the conditional expressions illustrated in FIG. 23.

As illustrated in FIG. 23, when the waste is stocked at the site Pt3, the controller 11 judges whether the weight data Wc, We, Wf and Wg meet the following conditional expressions (3) and (4).

Wc=We (3)

We=Wf+Wg (4)

The conditional expression (3) is used for judging whether a weight of the waste measured after the waste was carried to the site Pt3 from the Pt2 is reduced in comparison with a weight of the waste measured before the waste was carried to the site Pt3 from the Pt2. That is, it is judged in accordance with the conditional expression (3) whether the waste was illegally dumped while the waste was carried to the site Pt3 from the Pt2.

The conditional expression (4) is used for judging whether a weight of the waste measured after the waste was disassembled is reduced in comparison with a weight of the waste measured before the waste was disassembled. That is, it is judged in accordance with the conditional expression (4) whether the waste was illegally dumped while the waste was disassembled and grouped into the secondary reusable and non-reusable parts.

If the controller 11 judges that the weight data stored in the administration data memory 17 meet the conditional expressions (3) and (4), that is, the controller 11 judges that the waste was not illegally dumped (YES in step S714), the controller 11 writes “No Problem” into a column of the judgment result of the weight data, in step S715.

If the controller 11 judges that the weight data stored in the administration data memory 17 do not meet the conditional expressions (3) and/or (4), that is, the controller 11 judges that the waste might be illegally dumped (NO in step S714), the controller 11 writes “Problem” into a column of the judgment result of the weight data, in step S716.

Then, the controller 11 checks the part-number data Nc, Ne, Nf and Ng to judge whether the waste is legally disposed of, in step S717.

The judgment as to whether the waste is legally disposed of is made through the use of the conditional expressions illustrated in FIG. 24.

As illustrated in FIG. 24, when the waste is stocked at the site Pt3, the controller 11 judges whether the part-number data Nc, Ne, Nf and Ng meet the following conditional expressions (9) and (10).

Nc=Ne (9)

Ne=Nf+Ng (10)

The conditional expression (9) is used for judging whether a number of arts constituting the waste counted after the waste was carried to the site Pt3 from the Pt2 is reduced in comparison with a number of parts constituting the waste counted before the waste was carried to the site Pt3 from the Pt2. That is, it is judged in accordance with the conditional expression (9) whether the waste was illegally dumped while the waste was carried to the site Pt3 from the Pt2.

The conditional expression (10) is used for judging whether a number of parts constituting the waste counted after the waste was disassembled is reduced in comparison with a number of parts constituting the waste counted before the waste was disassembled. That is, it is judged in accordance with the conditional expression (10) whether the waste was illegally dumped while the waste was disassembled and grouped into the secondary reusable and non-reusable parts.

If the controller 11 judges that the part-number data stored in the administration data memory 17 meet the conditional expressions (9) and (10), that is, the controller 11 judges that the waste was not illegally dumped (YES in step S717), the controller 11 writes “No Problem” into a column of the judgment result of the part-number data, in step S718.

If the controller 11 judges that the part-number data stored in the administration data memory 17 do not meet the conditional expressions (9) and/or (10), that is, the controller 11 judges that the waste might be illegally dumped (NO in step S717), the controller 11 writes “Problem” into a column of the judgment result of the part-number data, in step S719.

Then, the controller 11 checks whether “Problem” is written in any columns of the judgment result in the waste administration data, in step S720.

When “Problem” is written in any one of columns of the judgment result in the waste administration data (YES in step S720), the controller 11 transmits a warning message to the waste-reuser's terminal device 50 to request the waste-reuser's terminal device 50 to temporally stop disposal of the waste, in step S721. For instance, the controller 11 transmits an e-mail to the waste-reuser's terminal device 50 through the radio-signal transceiver 12.

When “No Problem” is written in all of columns of the judgment result in the waste administration data (No in step S720), the controller 11 transmits a message of “No Problem” indicating that the waste was legally disposed of, to the waste-reuser's terminal device 50, in step S722.

The controller 51 of the waste-reuser's terminal device 50 judges whether a message of “No Problem” was received, in step S723.

If the controller 51 judges that a message of “Problem” was received (NO in step S723), the controller 51 ends the judgment process.

If the controller 51 judges that a message of “No Problem” was received for all of columns of the judgment result (YES in step S723), the controller 51 transmits a request of reusing or recycling the waste to the waste-recycler's terminal device 60, in step S724.

Then, the waste-reuser 400 transmits a message that the test to the waste at the site Pt3 was completed, to the host server 10, in step S725.

Then, the waste-reuser 400 stocks the secondary reusable parts at the site Pt3, and carries the non-reusable parts to the site Pt4. The waste-reuser 400 transmits a message that the non-reusable parts were carried to the sites Pt4, to the host server 10 through the waste-reuser's terminal device 50, in step S726.

Then, the waste-reuser 400 inputs kinds and numbers of the secondary reusable parts stocked at the site Pt3 into the waste-reuser's terminal device 50 through the data input device 54, in step S727.

Then, the controller 51 of the waste-reuser's terminal device 50 transmits data indicative of the input kinds and numbers of the secondary reusable parts stocked at the site Pt3, to the host server, in step S728.

On receipt of the data from the waste-reuser's terminal device 50, the controller 11 of the host server 10 stores the received data into the administration data memory 17 as recycle data.

Thus, the judgment carried out in the site Pt3 as to whether the waste is illegally dumped is completed.

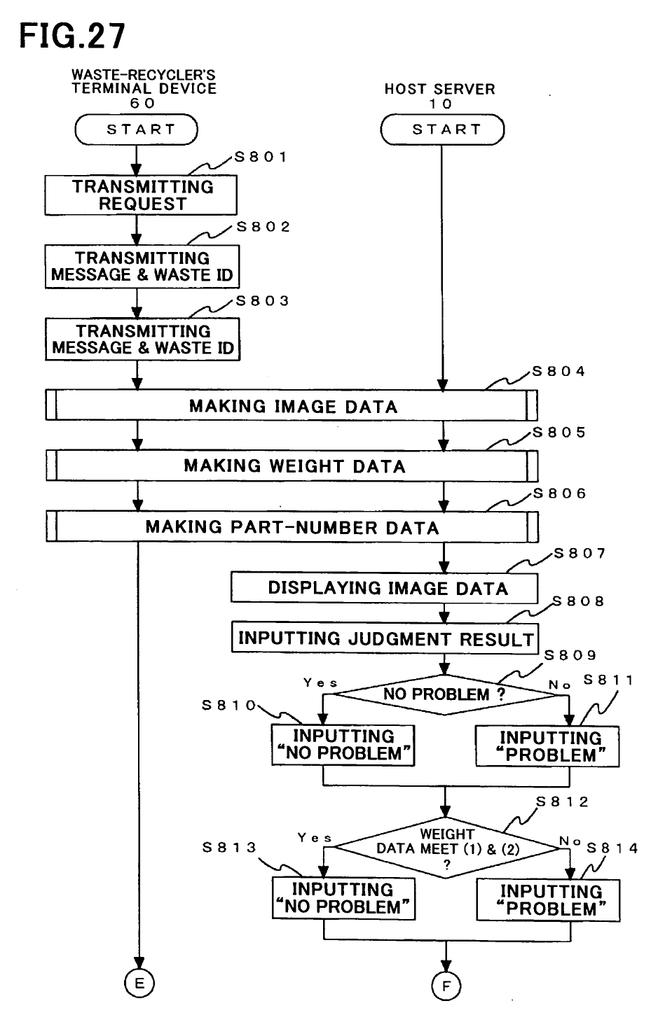

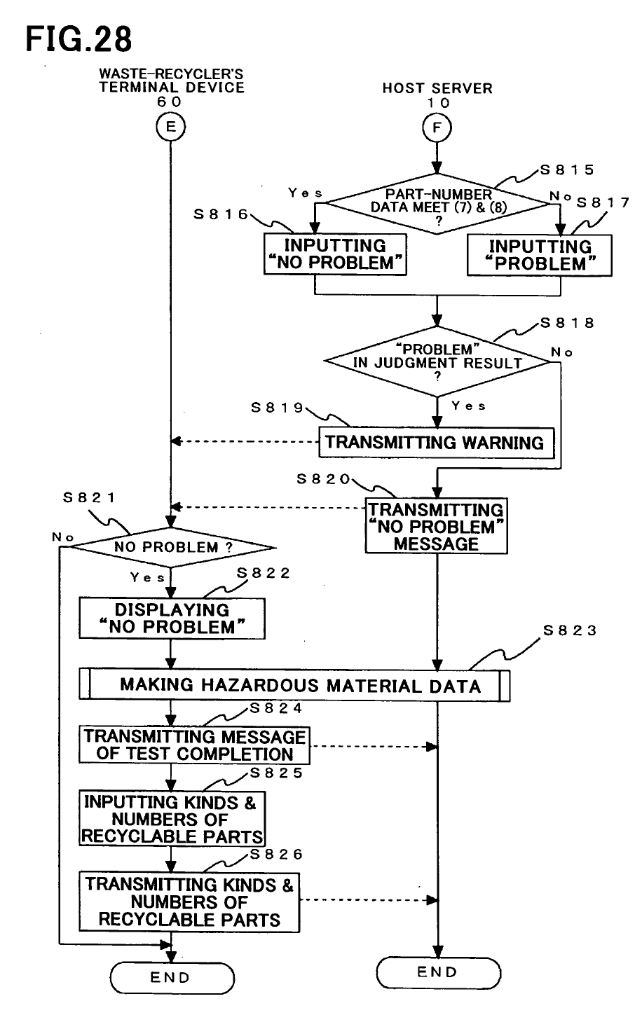

FIGS. 27 and 28 are flow charts showing steps to be carried out when it is judged at the site Pt4 whether waste is illegally dumped.

Hereinbelow are explained steps carried out at the site Pt4 for judging whether waste is illegally dumped, with reference to FIGS. 27 and 28.

The waste-recycler's terminal device 60 receives a request of recycling waste, from the second waste-collector's terminal device 40 and the waste-reuser's terminal device 50, in step S801. The request includes the waste ID identifying waste, that is, the waste except the firstly and secondary reusable parts.

When the waste arrives at the site Pt4 from the Pt2, the waste-recycler 500 transmits a message that the waste from which the firstly reusable parts were removed was carried to the site Pt4, to the host server 10 together with the waste ID through the radio-signal transceiver 62 of the waste-recycler's terminal device 60, in step S802.

When the waste arrives at the site Pt4 from the Pt3, the waste-recycler 500 transmits a message that the waste from which the secondary reusable parts were removed was carried to the site Pt4, to the host server 10 together with the waste ID through the radio-signal transceiver 62 of the waste-recycler's terminal device 60, in step S803.

Whichever step among the steps S802 and S803 may be carried out first in accordance with arrival time of the waste to the site Pt4 from the site Pt2 or Pt3.

Then, the waste-recycler 500 makes image data of the waste by means of the image reader 66 of the waste-recycler's terminal device 60, in step S804. The image data is made by the waste-recycler's terminal device 60, and then, is transmitted to the host server 10 together with the waste ID in the same steps as the steps illustrated in FIG. 16 to be carried out by the first waste-collector's terminal device 30.

Then, the waste-recycler 500 weighs the waste from which the firstly reusable parts were removed and the waste from which the secondary reusable parts were removed, at the site Pt4, in step S805. The weight data is made by the waste-recycler's terminal device 60, and then, is transmitted to the host server 10 together with the waste ID in the same steps as the steps illustrated in FIG. 17 to be carried out by the first waste-collector's terminal device 30. The thus obtained data indicative of a weight of the waste from which the firstly reusable parts were removed is referred to as weight data Wh, and the data indicative of a weight of the waste from which the secondary reusable parts were removed is referred to as weight data Wi.

Then, the waste-recycler 500 counts parts constituting the waste from which the firstly reusable parts were removed, and further counts parts constituting the waste from which the secondary reusable parts were removed, at the site Pt4, in step S806. The part-number data is made by the waste-recycler's terminal device 60, and then, is transmitted to the host server 10 together with the waste ID in the same steps as the steps illustrated in FIG. 18 to be carried out by the first waste-collector's terminal device 30. The thus obtained data indicative of a number of the parts constituting the waste from which the firstly reusable parts were removed is referred to as part-number data Nh, and the data indicative of a number of the parts constituting the waste from which the secondary reusable parts were removed is referred to as part-number data Ni.

Then, the controller 11 displays the image data of the waste from which the firstly reusable parts were removed, having been input at the sites Pt2 and Pt4, and the image data of the waste from which the secondary reusable parts were removed, having been input at the sites Pt3 and Pt4, in the display unit 13, in step S807.

Viewing the image data of the waste from which the firstly reusable parts were removed, displayed in the display unit 13, the system administrator judges whether the parts are lost or replaced before and after the waste was carried to the site Pt4 from the site Pt2, that is, whether the waste was illegally dumped while being carried to the site Pt4 from the site Pt2.

Further, viewing the image data of the waste from which the secondary reusable parts were removed, displayed in the display unit 13, the system administrator judges whether the parts are lost or replaced before and after the waste was carried to the site Pt4 from the site Pt3, that is, whether the waste was illegally dumped while being carried to the site Pt4 from the site Pt3.

Then, the system administrator inputs the result of judgment “No Problem” or “Problem” into the host server 10 through the data input device 14, in step S808. If the result of judgment “No Problem” is input (YES in step S809), the controller 11 inputs “No Problem” into a column of judgment result of the image data associated with the site Pt4 in the waste administration data stored in the administration data memory 17, in step S810.

If the result of judgment “Problem” is input (NO in step S809), the controller 11 inputs “Problem” into a column of judgment result of the image data associated with the site Pt4 in the waste administration data stored in the administration data memory 17, in step S811.

Then, the controller 11 checks the weight data Wd, Wg, Wh and Wi to judge whether the waste is legally disposed of, in step S812. The judgment as to whether the waste is legally disposed of is made through the use of the conditional expressions illustrated in FIG. 23.

As illustrated in FIG. 23, when the waste is stocked at the site Pt4, the controller 11 judges whether the weight data Wd, Wg, Wh and Wj meet the following conditional expressions (5) and (6).

Wd=Wh (5)

Wg=Wi (6)

The conditional expression (5) is used for judging whether a weight of the waste measured after the waste was carried to the site Pt4 from the Pt2 is reduced in comparison with a weight of the waste measured before the waste was carried to the site Pt4 from the Pt2. That is, it is judged in accordance with the conditional expression (5) whether the waste was illegally dumped while the waste was carried to the site Pt4 from the Pt2.

The conditional expression (6) is used for judging whether a weight of the waste measured after the waste was carried to the site Pt4 from the Pt3 is reduced in comparison with a weight of the waste measured before the waste was carried to the site Pt4 from the Pt3. That is, it is judged in accordance with the conditional expression (6) whether the waste was illegally dumped while the waste was carried to the site Pt4 from the Pt3.

If the controller 11 judges that the weight data stored in the administration data memory 17 meet the conditional expressions (5) and (6), that is, the controller 11 judges that the waste was not illegally dumped (YES in step S812), the controller 11 writes “No Problem” into a column of the judgment result of the weight data, in step S813.

If the controller 11 judges that the weight data stored in the administration data memory 17 do not meet the conditional expressions (5) and/or (6), that is, the controller 11 judges that the waste might be illegally dumped (NO in step S812), the controller 11 writes “Problem” into a column of the judgment result of the weight data, in step S814.

Then, the controller 11 checks the part-number data Nd, Ng, Nh and Ni to judge whether the waste is legally disposed of, in step S815.

The judgment as to whether the waste is legally disposed of is made through the use of the conditional expressions illustrated in FIG. 24.

As illustrated in FIG. 24, when the waste is stocked at the site Pt4, the ontroller 11 judges whether the part-number data Nd, Ng, Nh and Ni meet the following conditional expressions (11) and (12).

Nd=Nh (11)

Ng=Ni (12)

The conditional expression (11) is used for judging whether a number of parts constituting the waste counted after the waste was carried to the site Pt4 from the Pt2 is reduced in comparison with a number of parts constituting the waste counted before the waste was carried to the site Pt4 from the Pt2. That is, it is judged in accordance with the conditional expression (11) whether the waste was illegally dumped while the waste was carried to the site Pt4 from the Pt2.

The conditional expression (12) is used for judging whether a number of parts constituting the waste counted after the waste was carried to the site Pt4 from the Pt3 is reduced in comparison with a number of parts constituting the waste counted before the waste was carried to the site Pt4 from the Pt3. That is, it is judged in accordance with the conditional expression (12) whether the waste was illegally dumped while the waste was carried to the site Pt4 from the Pt3.

If the controller 11 judges that the part-number data stored in the administration data memory 17 meet the conditional expressions (11) and (12), that is, the controller 11 judges that the waste was not illegally dumped (YES in step S815), the controller 11 writes “No Problem” into a column of the judgment result of the part-number data, in step S816.

If the controller 11 judges that the part-number data stored in the administration data memory 17 do not meet the conditional expressions (11) and/or (12), that is, the controller 11 judges that the waste might be illegally dumped (NO in step S815), the controller 11 writes “Problem” into a column of the judgment result of the part-number data, in step S817.

Then, the controller 11 checks whether “Problem” is written in any columns of the judgment result in the waste administration data, in step S818.

When “Problem” is written in any one of columns of the judgment result in the waste administration data (YES in step S818), the controller 11 transmits a warning message to the waste-recycler's terminal device 60 to request the waste-recycler's terminal device 60 to temporally stop disposal of the waste, in step S819. For instance, the controller 11 transmits an e-mail to the waste-recycler's terminal device 60 through the radio-signal transceiver 12.

When “No Problem” is written in all of columns of the judgment result in the waste administration data (No in step S818), the controller 11 transmits a message of “No Problem” indicating that the waste was legally disposed of, to the waste-recycler's terminal device 60, in step S820.

The controller 61 of the waste-recycler's terminal device 60 judges whether a message of “No Problem” was received, in step S821.

If the controller 61 judges that a message of “Problem” was received (NO in step S821), the controller 61 ends the judgment process.

If the controller 61 judges that a message of “No Problem” was received for all of columns of the judgment result (YES in step S821), the controller 61 causes the display unit 63 to display receipt of the message, in step S822.

Confirming the receipt of the message displayed in the display unit 63, the waste-recycler 500 disassembles the waste from which the first reusable parts were removed and the waste from which the secondary reusable parts were removed, and groups them into parts.

Then, the waste-recycler 500 takes hazardous material data to each of the parts through the use of the waste-recycler's terminal device 60, in step S823. The hazardous material data is collected by the waste-recycler's terminal device 60, and then, is transmitted to the host server 10 together with the waste ID in the same steps as the steps illustrated in FIG. 14 to be carried out by the first waste-collector's terminal device 30.

The waste-recycler 500 removes hazardous material out of the parts judged to contain the hazardous material. The waste-recycler 500 stocks reusable parts and materials as recycled parts and materials, and dumps parts which are not reusable. An industrial waste disposer may receive such parts not reusable from the waste-recycler 500, and dump them.

Then, the waste-recycler 500 transmits a message that the recycling of the waste was completed, to the host server 10 together with the waste ID of the recycled or disposed of, through the waste-recycler's terminal device 60, in step S824.

Then, the waste-recycler 500 inputs kinds and numbers of the recyclable parts stocked at the site Pt4 into the waste-recycler's terminal device 60 through the data input device 64, in step S825.

Then, the controller 61 of the waste-recycler's terminal device 60 transmits data indicative of the input kinds and numbers of the recyclable parts stocked at the site Pt4, to the host server, in step S826.

On receipt of the data from the waste-recycler's terminal device 60, the controller 11 of the host server 10 stores the received data into the administration data memory 17 as recycle data.

Thus, the judgment carried out in the site Pt4 as to whether the waste is illegally dumped is completed.

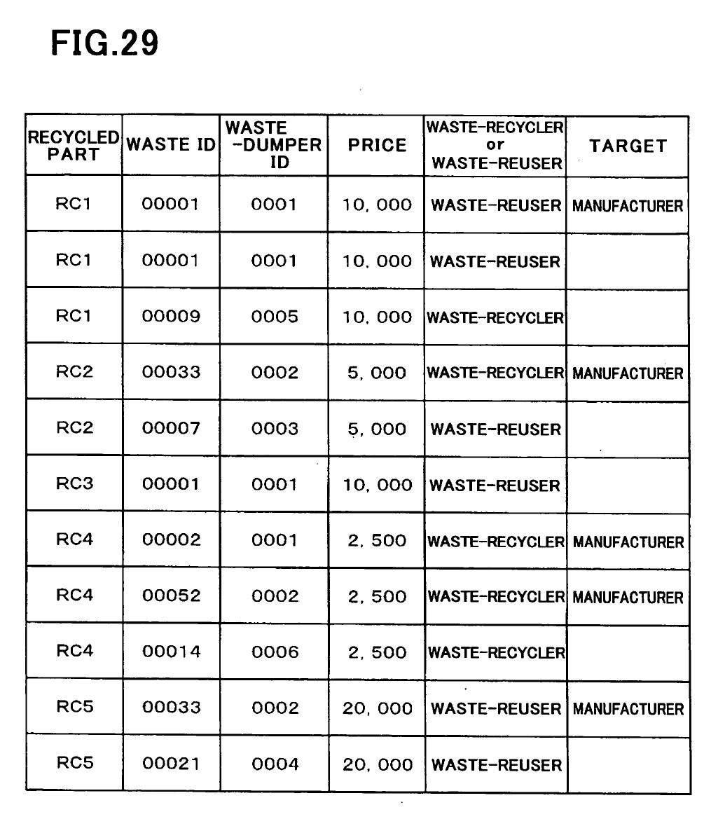

FIG. 29 illustrates an example of the recycle data in the first embodiment.

As illustrated in FIG. 29, the recycle data includes a name of each of recycled parts, a waste ID of waste of which each of the recycled parts constitutes, a waste-dumper ID from which the waste is dumped, a price of each of the recycled parts, a waste-recycler or a waste-reuser providing each of the recycled parts, and a target to which each of the recycled parts is to be sold.

The manufacturer 100 can purchase the recycled parts as parts of a product through the manufacturer's terminal device 70.

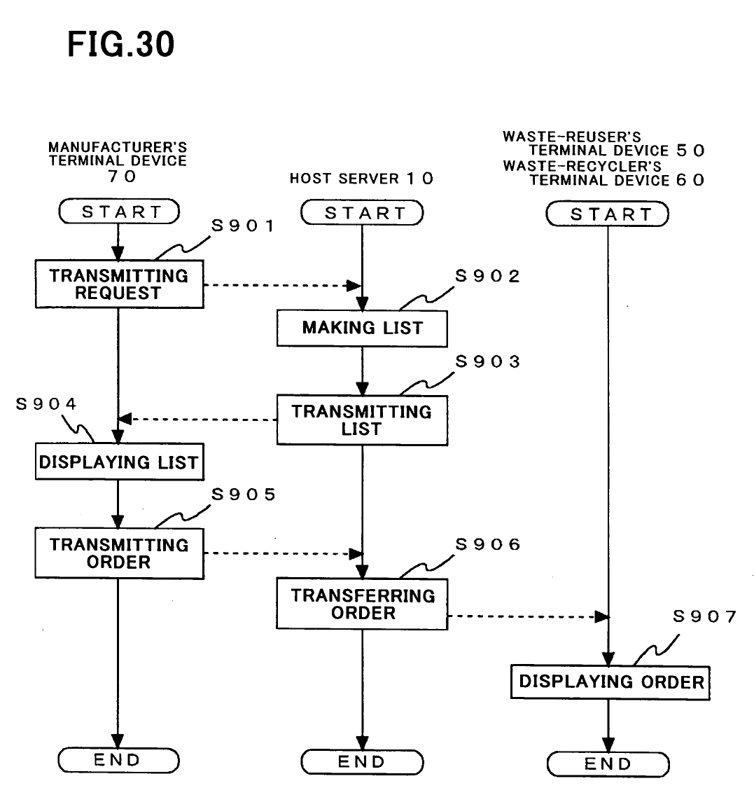

FIG. 30 is a flow-chart showing steps to be carried out when reusable or recyclable parts are ordered by the manufacturer's terminal device 70. Hereinbelow is explained a system in which the manufacturer 100 manufactures a product including a reusable or recyclable part.

First, the controller 71 transmits a request to the host server 10 to send a list of recycled parts to the manufacturer's terminal device 70, in step S901.

On receipt of the request from the manufacturer's terminal device 70, the controller 11 of the host server 10 makes a list of recycled parts, based on the recycle data stored in the administration data memory 17, in step S902.

Then, the controller 11 transmits the list to the manufacturer's terminal device 70 through the radio-signal transceiver 12, in step S903.

On receipt of the list from the host server 10, the controller 71 causes the display unit 73 to display the received list, in step S904.

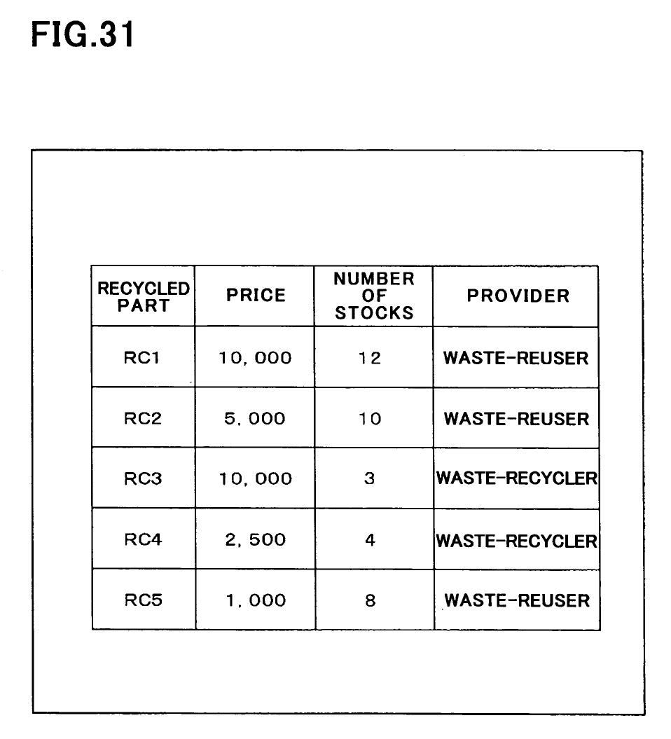

FIG. 31 illustrates an example of the list of recycled parts, displayed in the display device 73 of the manufacturer's terminal device 70.

As illustrated in FIG. 31, the list includes a price, a number of stocks, and a provider for each of recycled parts.

Viewing the list, the manufacturer 100 inputs an order including a name and an address of the manufacturer 100, and a name and a number of a recycled part which the manufacturer 100 purchases, into the manufacturer's terminal device 70. Then, the controller 71 transmits the order to the host server through the radio-signal transceiver 72, in step S905.

On receipt of the order from the manufacturer's terminal device 70, the controller 11 of the host server 10 transmits the order to the waste-reuser's terminal device 50 and/or the waste-recycler's terminal device 60 of the waste-reuser 400 and/or the waste-recycler 500 which stock(s) the ordered recycled parts, in step S906.

On receipt of the order, the controller(s) 51 and/or 61 displays the received order in the display unit(s) 53 and/or 63, in step S907.

Then, the waste-reuser 400 and/or the waste-recycler 500 deliver(s) the ordered recycled parts to the site Pt5 where the manufacturer 100 manufactures a product.

The manufacturer 100 manufactures a product including the recycled parts received from the waste-reuser 400 and/or the waste-recycler 500.

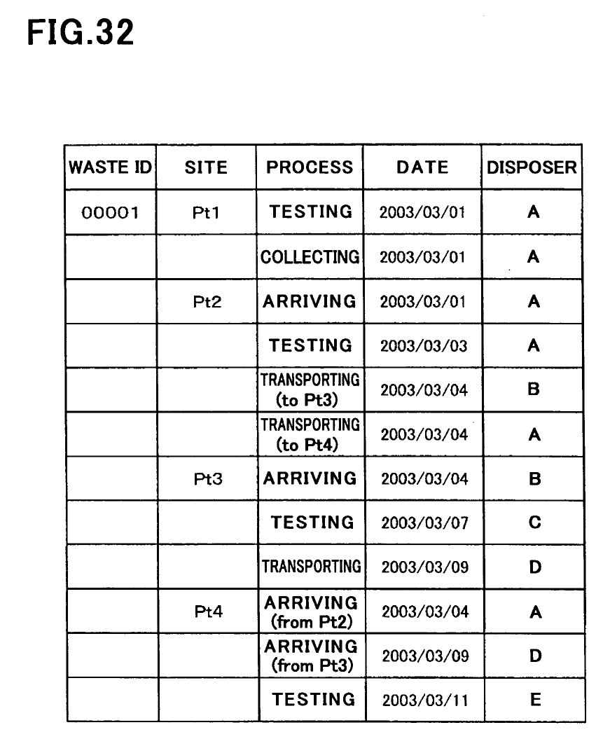

FIG. 32 illustrates an example of progress data indicating a progress in disposal of waste. Hereinbelow is explained registration of the progress data into the administration data memory 17, with reference to FIG. 32.

The administration data memory 17 stores the progress data for each of waste IDs. FIG. 32 illustrates the progress data of the waste identified with the waste ID “00001” as an example.

As illustrated in FIG. 32, the progress data indicates a progress of disposal of waste in each of the sites Pt1 to Pt4. The progress data includes dates at which test, collection, arrival and transportation of wastes were carried out. Furthermore, the progress data includes names of disposers having carried out the test, collection, receipt and transportation of wastes.

On receipt of a message indicative of the completion of disposal of waste from the terminal devices 30, 40, 50 and 60, the controller 11 of the host server 10 writes a date and time of receipt of the message into the progress stored in the administration data memory 17 as a date and time at which the test, collection, receipt or transportation of wastes has been completed. The controller 11 further writes the names of disposers into the progress data.

The waste-dumper 200 can get data relating to his/her waste through the waste-dumper's terminal device 20.

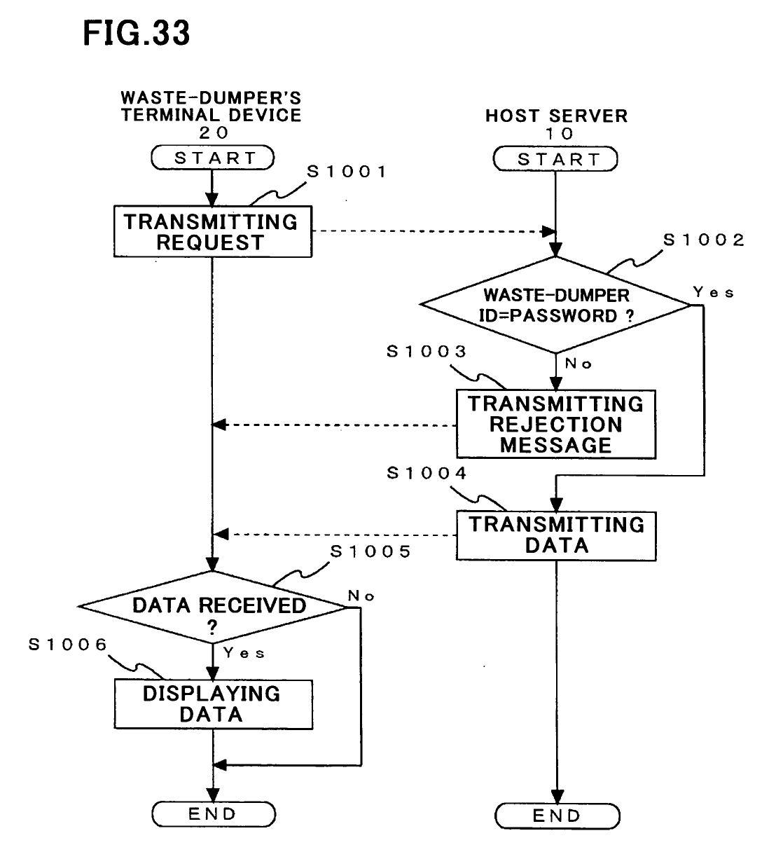

FIG. 33 is a flow-chart showing steps to be carried out when the waste-dumper 200 gets data relating to his/her waste through the waste-dumper's terminal device 20. Hereinbelow is explained how the waste-dumper 200 gets the data through the waste-dumper's terminal device 20, with reference to FIG. 33.

The waste-dumper's terminal device 20 transmits a request to the host server 10 together with the waste-dumper ID and the password to transmit data relating to the waste to the waste-dumper's terminal device 20, in step S1001.

On receipt of the request together with the waste-dumper ID and the password, the controller 11 of the host server 10 retrieves the client data stored in the client data memory 16 to authenticate the waste-dumper 200 by judging whether the received waste-dumper ID and password are associated with the client data, in step S1002.

If it is judged that the received waste-dumper ID and password are not associated with the client data (NO in step S1002), the controller 11 transmits a message that the waste-dumper 200 is not allowed to get data relating to the waste, to the waste-dumper's terminal device 20, in step S1003.

If it is judged that the received waste-dumper ID and password are associated with the client data (YES in step S1002), the controller 11 reads data associated with the received waste-dumper ID, out of the administration data memory 17, and transmits the data to the waste-dumper's terminal device 20, in step S1004. The data transmitted to the waste-dumper's terminal device 20 includes at least one of the waste administration data, the image data, the progress data and the recycle data.

Hereinbelow is explained transmission of data relating to waste on the assumption that the host server 10 receives a request of transmitting recycle data to the waste-dumper's terminal device 20.

The controller 11 of the host server 10 reads recycle data identified with the waste-dumper Id received together with the request, among the recycle data stored in the administration data memory 17, out of the administration data memory 17.

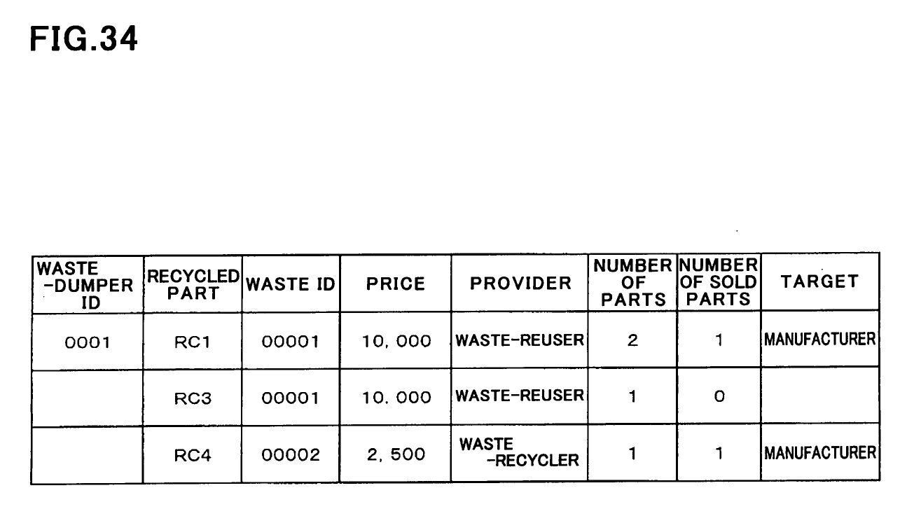

The administration data memory 17 stores therein the recycle data as illustrated in FIG. 29. On receipt of the request together with the waste-dumper ID “0001”, the controller 11 reads out the recycled parts RC1, RC3 and RC4 all associated with the waste-dumper “0001”, and makes the recycle data an example of which is illustrated in FIG. 34.

As illustrated in FIG. 34, the recycle data made by the controller 11 includes a name of each of recycled parts which used to constitute waste dumped by a certain waste-dumper, a waste ID of waste of which each of the recycled parts constitutes, a price of each of the recycled parts, a waste-recycler or a waste-reuser providing each of the recycled parts, a number of each of the recycled parts, a number of sold recycled parts, and a target to which each of the recycled parts is to be sold.

Then, the controller 21 of the waste-dumper's terminal device 20 judges whether the data relating to waste is received from the host server 10, in step S1005.

When the controller 21 judges that a message indicating rejection of transmission of the data relating to waste is received (NO in step S1005), the controller 21 displays the message in the display unit 23, and ends the procedure.

When the controller 21 judges that the data relating to waste has been received (YES in step S1005), the controller 21 displays the received data in the display unit, in step S1006.

Viewing the data displayed in the display unit 23, the waste-dumper confirms a progress of disposal of his/her waste and a test result as to whether his/her waste is illegally dumped.

In the first embodiment, the host server 10 receives data from one of the terminal devices 30, 40, 50 and 60. However, the host server 10 may receive data concurrently from two or more of the terminal devices 30, 40, 50 and 60.

In the first embodiment, each of the terminal devices 30, 40, 50 and 60 collects data relating to waste at each of the sites Pt1, Pt2, Pt3 and Pt4, and transmits the data to the host server 10. One terminal among the terminal devices 30, 40, 50 and 60 may collect data relating to waste at a plurality of sites among the sites Pt1, Pt2, Pt3 and Pt4, and may transmit the data to the host server 10. For instance, one terminal device can collect data relating to waste at a plurality of sites, if the terminal device is designed to be comprised of a mobile terminal such as a cellular phone, a terminal in the personal handy-phone system (PHS), a personal digital assistant (PDA), or a note-book type personal computer.

In accordance with the above-mentioned first embodiment, it is checked whether waste is illegally dumped by comparing the image data, the weight data and the part-number data in each of steps in a waste-recycling process, and then, the check results are output in the form of a report. Hence, it is possible to prevent illegal dumping of waste in a waste-recycling process.

In accordance with the first embodiment, the waste-dumper 200 may request the host server 10 to transmit the data indicative of waste dumped by himself/herself to the waste-dumper's terminal device 20. On receipt of the request from the waste-dumper's terminal device 20, the host server 20 carries out authentication as to whether a person who transmitted a request is really a waste-dumper, and then, if the person is really the waste-dumper 200, the host server 10 transmits the data indicative of a progress in recycling his/her waste and/or the results of checking whether his/her waste is illegally dumped, to the waste-dumper's terminal device 20.

Accordingly, the waste-dumper 200 can readily and soon check whether his/her waste is legally disposed of in a process of recycling his/her waste. Furthermore, it is possible to prevent the data relating to his/her waste from leaking to a third party.

In accordance with the first embodiment, each of the first waste-reuser's terminal 30 and the waste-recycler's terminal device 60 transmits the waste ID of each of parts constituting the waste, to the host server 10. On receipt of the waste ID, the host server 10 checks whether each of the parts contains hazardous material therein. Hence, the waste-reuser 400 or the waste-recycler 500 can readily know whether the waste contains hazardous material, and can properly dispose of the waste.

While the present invention has been described in connection with certain preferred embodiments, it is to be understood that the subject matter encompassed by way of the present invention is not to be limited to those specific embodiments. On the contrary, it is intended for the subject matter of the invention to include all alternatives, modifications and equivalents as can be included within the spirit and scope of the following claims.

The entire disclosure of Japanese Patent Application No. 2003-121291 filed on Apr. 25, 2003 including specification, claims, drawings and summary is incorporated herein by reference in its entirety.

What is claimed is:

1. A system for disposing of wastes, comprising a central processing unit which receives data indicative of a condition of waste in each of steps in a waste-recycling process, compares said data in each of said steps to one another, and judges whether said condition of waste changes in each of said steps.

2. The system as set forth in claim 1, wherein said central processing unit judges whether a part or parts constituting said waste is (are) in short in each of said steps.

3. A system for disposing of wastes, comprising a plurality of terminal devices located at sites in which steps in a waste-recycling process are carried out, a network, and a host server making communication with said terminal devices through said network,
wherein each of said terminal devices transmits data indicative of a condition of waste in each of said steps, to said host server, and
said host server compares said data in each of said steps to one another to judge whether said condition of waste changes in each of said steps.

4. The system as set forth in claim 3, wherein said host server judges whether a part or parts constituting said waste is (are) in short in each of said steps.

5. The system as set forth in claim 3, wherein said host server compares said data indicative of a condition of waste before said waste is carried to said data indicative of a condition of said waste after said waste is carried.

6. The system as set forth in claim 3, wherein said host server compares said data indicative of a condition of waste before said waste is disassembled to said data indicative of a condition of said waste after said waste is disassembled.

7. The system as set forth in claim 3, wherein each of said terminal devices transmits image data of said waste in each of said steps to said host server.

8. The system as set forth in claim 3, wherein each of said terminal devices transmits data indicative of a weight of said waste in each of said steps to said host server, and said host server compares said data to one another to judge whether a weight of said waste reduces.

9. The system as set forth in claim 3, wherein each of said terminal devices transmits data indicative of a number of parts constituting said waste in each of said steps to said host server, and said host server compares said data to one another to judge whether said number of parts reduces.

10. The system as set forth in claim 3, wherein said host server includes a memory storing therein data indicative of whether a part or parts constituting said waste include(s) hazardous material,
each of said terminal devices transmits data indicative of parts constituting said waste to said host server, and
said host server compares said data received from each of said terminal devices to said data stored in said memory to judge whether said parts constituting said waste include said hazardous material.

11. The system as set forth in claim 3, further comprising a waste-dumper's terminal device making communication with said host server through said network and operated by a dumper of said waste,
wherein said host server receives data transmitted from each of said terminal devices, stores the received data therein, and transmits said data to said waste-dumper's terminal device on receipt of a request to do so from said waste-dumper's terminal device.

12. The system as set forth in claim 3, wherein each of said terminal devices transmits data indicative of date and time at which each of said steps was carried out, to said host server.

13. The system as set forth in claim 3, wherein each of said terminal devices transmits data indicative of a condition of said waste in at least one of a waste-gathering step and a waste-disassembling/grouping step, to said host server.

14. A method of disposing of wastes, comprising:
(a) producing data indicative of a condition of waste in each of steps in a waste-recycling process;
(b) comparing said data in each of said steps to one another; and
(c) judging whether said condition of waste changes in each of said steps.

15. The method as set forth in claim 14, wherein it is judged in said step (c) whether a part or parts constituting said waste is (are) in short in each of said steps.

16. A method of disposing of wastes through a system comprising a plurality of terminal devices located at sites in which steps in a waste-recycling process are carried out, a network, and a host server making communication with said terminal devices through said network,
said method including:
(a) transmitting data indicative of a condition of waste in each of said steps, to said host server from each of said terminal devices, and
(b) comparing said data in each of said steps to one another in said host server to judge whether said condition of waste changes in each of said steps.

17. The method as set forth in claim 16, wherein it is judged in said step (b) whether a part or parts constituting said waste is (are) in short in each of said steps.

18. The method as set forth in claim 16, wherein said data indicative of a condition of waste before said waste is carried is compared in said step (b) to said data indicative of a condition of said waste after said waste is carried.

19. The method as set forth in claim 16, wherein said data indicative of a condition of waste before said waste is disassembled is compared in said step (b) to said data indicative of a condition of said waste after said waste is disassembled.

20. The method as set forth in claim 16, wherein image data of said waste in each of said steps is transmitted in said step (a) to said host server from each of said terminal devices.

21. The method as set forth in claim 16, wherein data indicative of a weight of said waste in each of said steps is transmitted in said step (a) to said host server from each of said terminal devices, and said data is compared in said step (b) to one another to judge whether a weight of said waste reduces.

22. The method as set forth in claim 16, wherein each of said terminal devices transmits data indicative of a number of parts constituting said waste in each of said steps to said host server, and said host server compares said data to one another to judge whether said number of parts reduces.

23. The method as set forth in claim 16, further including storing data indicative of whether a part or parts constituting said waste include(s) hazardous material, into a memory of said host server, and wherein data indicative of parts constituting said waste is transmitted in said step (a) to said host server from each of said terminal devices, and said data received from each of said terminal devices is compared in said step (b) to said data stored in said memory to judge whether said parts constituting said waste include said hazardous material.

24. The method as set forth in claim 16, further comprising transmitting said data to a waste-dumper's terminal device making communication with said host server through said network and operated by a dumper of said waste, on receipt of a request to do so from said waste-dumper's terminal device.

25. The method as set forth in claim 16, wherein data indicative of date and time at which each of said steps was carried out is transmitted in said step (a) to said host server from each of said terminal devices.

26. The method as set forth in claim 16, wherein data indicative of a condition of said waste in at least one of a waste-gathering step and a waste-disassembling/grouping step is transmitted to said host server from each of said terminal devices.

27. A program for causing a computer to carry out a method of disposing of wastes, wherein steps executed by said computer in accordance with said program include:
(a) receiving data indicative of a condition of waste in each of steps in a waste-recycling process;
(b) comparing said data in each of said steps to one another; and
(c) judging whether said condition of waste changes in each of said steps.

28. The program as set forth in claim 27, wherein it is judged in said step (c) whether a part or parts constituting said waste is (are) in short in each of said steps.

29. The program as set forth in claim 27, wherein said data indicative of a condition of waste before said waste is carried is compared in said step (b) to said data indicative of a condition of said waste after said waste is carried.

30. The program as set forth in claim 27, wherein said data indicative of a condition of waste before said waste is disassembled is compared in said step (b) to said data indicative of a condition of said waste after said waste is disassembled.

31. The program as set forth in claim 27, wherein image data of said waste in each of said steps is received in said step (a).

32. The program as set forth in claim 27, wherein data indicative of a weight of said waste in each of said steps is received in said step (a), and said data is compared in said step (b) to one another to judge whether a weight of said waste reduces.

33. The program as set forth in claim 27, wherein data indicative of a number of parts constituting said waste in each of said steps is received in said step (a), and said data is compared in said step (b) to one another to judge whether said number of parts reduces.

34. The program as set forth in claim 27, wherein data indicative of parts constituting said waste is received in said step (a), and said data is compared in said step (b) to data indicative of whether a part or parts constituting said waste include(s) hazardous material, to judge whether said parts constituting said waste include said hazardous material.

35. The program as set forth in claim 27, wherein said steps executed by said computer include transmitting said data to a waste-dumper's terminal device making communication with said host server through said network and operated by a dumper of said waste, on receipt of a request to do so from said waste-dumper's terminal device.

36. A server which collects data indicative of a condition of waste in each of steps in a waste-recycling process, compares said data in each of said steps to one another, and judges whether said condition of waste changes in each of said steps.

37. The server as set forth in claim 36, wherein said server judges whether a part or parts constituting said waste is (are) in short in each of said steps.

38. The server as set forth in claim 36, wherein said server judges whether a part or parts constituting said waste is (are) in short in each of said steps.

39. The server as set forth in claim 36, wherein said server compares said data indicative of a condition of waste before said waste is carried to said data indicative of a condition of said waste after said waste is carried.

40. The server as set forth in claim 36, wherein said server compares said data indicative of a condition of waste before said waste is disassembled to said data indicative of a condition of said waste after said waste is disassembled.

41. The server as set forth in claim 36, wherein said server receives image data of said waste in each of said steps.

42. The server as set forth in claim 36, wherein said server receives data indicative of a weight of said waste in each of said steps, and compares said data to one another to judge whether a weight of said waste reduces.

43. The server as set forth in claim 36, wherein said server receives data indicative of a number of parts constituting said waste in each of said steps, and compares said data to one another to judge whether said number of parts reduces.

44. The server as set forth in claim 36, further including a memory storing therein data indicative of whether a part or parts constituting said waste include(s) hazardous material,
and wherein said server receives data indicative of parts constituting said waste to said host server, and compares the received data to said data stored in said memory to judge whether said parts constituting said waste include said hazardous material.
